(19) United States
(12) Patent Application Publication
(10) Pub. No.: US 2025/0229417 A1
(43) Pub. Date: Jul. 17, 2025

(54) DEVICES, SYSTEMS, AND METHODS FOR TRANSFERRING PHYSICAL SKILLS TO ROBOTS

(71) Applicant: Standard Bots Company, Glen Cove, NY (US)

(72) Inventors: Evan Beard, Glen Cove, NY (US); Daniel Grover, Oakland, CA (US); Joseph Delgado, Miami, FL (US); Rob Irwin, Ladera Ranch, CA (US); Shanen Soltani Icely, Summerville, SC (US); Ben Niewood, New Rochelle, NY (US); James Cordle, Sea Cliff, NY (US); Jeremy Goldberg, New York, NY (US); Lee Gross, Lake Forest, CA (US); Dylan Knutson, Auburn, WA (US)

(21) Appl. No.: 19/022,923

(22) Filed: Jan. 15, 2025

Related U.S. Application Data
(60) Provisional application No. 63/621,944, filed on Jan. 17, 2024.
(60) Provisional application No. 63/559,781, filed on Feb. 29, 2024.

(51) Int. Cl. B25J 9/16

(52) U.S. Cl. CPC B25J 9/163; B25J 9/1633

(57) ABSTRACT

A robotic training system enabling intuitive skill transfer through human demonstration using paired devices, allowing robots to perform complex manipulation tasks traditionally requiring extensive manual programming or expensive hardware setups. Leader robotic devices configured for human manipulation and follower robotic devices replicate the leader's movements. Force sensors, torque sensors, or force-torque sensors measure and process force data, torque data, or force-torque data for recording training demonstrations for artificial intelligence (AI) models. Demonstration devices include user control interfaces, multiple workspace viewpoints, motion modification for haptic feedback, and interchangeable end effector tools. A control system enables automatic transitions between position and force control based on sensed interactions, while incorporating learned policies from demonstrations with visual and force data. Methods for robot programming leverage demonstration data, generating natural language descriptions of actions and human-readable narratives of robot programs. The system provides a comprehensive, low-cost solution for robot learning from human demonstration.

### PRIORITY

The present application claims priority to U.S. Provisional Patent Application No. 63/621,944 filed Jan. 7, 2024, and U.S. Provisional Patent Application No. 63/559,781, filed Feb. 29, 2024, each of which is incorporated by reference in its entirety.

### FIELD

The field of the present disclosure relates generally to robotics, and more specifically to the intersection of robotics and Artificial Intelligence (AI).

### BACKGROUND

Traditionally, robotic systems have been programmed through explicit step-by-step instructions that define fixed motion sequences for specific tasks. This procedural approach lacks the flexibility needed for robots to adapt to varying real-world conditions and learn new behaviors. While artificial intelligence (AI), which refers to computer systems that can learn and adapt their behavior based on data and experience, has been integrated into robotics, its application has largely been limited to perception tasks like object detection and localization, rather than controlling complex manipulation behaviors.

More recently, end-to-end AI models have emerged that can map directly from sensory inputs (like camera images and joint positions) to robot trajectories. However, training such models requires substantial amounts of demonstration data showing how humans would perform the target tasks. This has created a need for new devices and interfaces that can effectively capture human demonstrations and transfer that knowledge into neural networks that control robot actions.

The collection of high-quality demonstration data presents several key challenges. The demonstration interface must be intuitive for humans to use while still capturing precise enough information to train robot policies. The demonstrations need to include both visual observations and corresponding physical actions like forces and torques. The training system should also be able to handle multiple robot configurations and transfer learned skills between different robotic platforms.

What is needed are improved approaches for capturing and utilizing human demonstration data for robot training. Specifically, advances are needed in teleoperation interfaces that maintain both natural human control and precise data collection, portable demonstration devices that can capture rich sensory information, and robust methods for processing demonstration data into effective robot control policies. Additionally, solutions are needed for transferring learned skills between different robot configurations while maintaining performance.

### SUMMARY

The present disclosure overcomes limitations in traditional robotic systems through an integrated approach to robotic training, demonstration, and control that emphasizes guided learning and intuitive human interaction. Through this comprehensive integration of force-sensitive demonstration capture, intuitive training interfaces, and adaptive control strategies, the present disclosure significantly advances robotic learning and manipulation capabilities. The system enables robots to better understand and replicate complex physical interactions while maintaining precise control over force application and positioning.

Some aspects relate to a robotic training system utilizing coordinated leader and follower robotic devices. This system captures complex physical actions through at least one of, force sensors, torque sensors, or force-torque sensors mounted on either the leader robotic devices, follower robotic devices, or both. The system transmits and records force data, torque data, or force-torque data corresponding to physical actions like lifting, twisting, and pouring, creating rich demonstration data for training artificial intelligence models. The leader-follower system can be enhanced with user control interfaces mounted directly on the leader robotic devices, independent sensors providing multiple workspace viewpoints, and motion modification capabilities that adjust perceived weight and provide haptic feedback.

Other aspects relate to a handheld demonstration device for robotic skill capture. This device features a body portion manipulated by users and can be equipped with force sensors, torque sensors, or force-torque sensors that measure interaction forces during demonstrations. The device supports interchangeable electromechanical end effector tools mounted, for example, via an ISO pattern interface, with capabilities including interchangeable grippers and customizable fingers. The device can incorporate various cameras, including time-of-flight and stereo depth cameras, and may be integrated with mobile devices for synchronized viewpoint capture. The device includes electronic triggers and continuous-range control inputs for precise end effector activation during demonstrations.

Further aspects include an advanced robotic control system that processes demonstration data comprising force measurements, torque measurements, or force-torque measurements, as well as visual information from the demonstrator's perspective. This control system dynamically switches between position control for trajectory following and force control for interaction tasks, with transitions guided by real-time force sensing and learned policies. The system includes task verification capabilities through neural networks that analyze sensor data for completion status.

Further aspects include a control system that is enhanced by a novel programming method that generates natural language descriptions of robot actions based on force data, torque data, or force-torque data, visual information, and robot configuration parameters. This creates human-readable narrative sequences of robot programs, with capabilities for temporal segmentation of demonstration videos and labeled action tracking across demonstrations.

Supporting the above aspects are sophisticated training data generation systems that leverage scanning modules to capture three dimensional (3D) environmental data, simulation modules for synthetic training scenarios, and model selection systems that process natural language inputs to determine task requirements. The system can adapt foundation models using demonstrations while incorporating various prompts to guide task execution.

Covered embodiments are defined by the claims, not this summary. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

FIG. 1 is a schematic illustration depicting an example of a bayonet mounting system in accordance with embodiments of the present disclosure.

FIG. 2 is a schematic illustration depicting an example of robotic arms configured for use with the training methods described herein.

FIG. 3 is another schematic illustration depicting robotic arms configured for use with the training methods described herein.

FIG. 4 is a schematic illustration depicting a robot set-up in accordance with embodiments of the present disclosure.

FIG. 5 is another schematic illustration depicting a robot set-up in accordance with embodiments of the present disclosure.

FIG. 6 is a schematic illustration depicting one embodiment of a hand demonstration device in accordance with the present disclosure.

FIG. 7 shows a demonstration device support system with labeled components including a support plate, gimbal, and strap that work together to provide adjustable elbow support.

FIG. 8 illustrates a backpack-style support system featuring a dual gimbal rig, pulley, arm, shoulder straps, tension device, support, tension adjustment, strap, rope/line, and gripper manipulator components working together as an integrated wearable demonstration device.

FIG. 9 is a schematic illustration depicting a non-limiting example of a user interface (UI) that may be employed in accordance with the present disclosure to program a robot.

FIG. 10 is a schematic illustration depicting an example UI that guides a user step-by-step through a project-building process.

FIG. 11 is a schematic illustration depicting an example UI for selecting a foundational model for a project.

FIG. 12 is a schematic illustration depicting an example UI for managing training data and demonstrations, including an organized view of data elements.

FIG. 13 is a schematic illustration depicting an example labeling interface for annotating data to train a model.

FIG. 14 is a schematic illustration depicting an example instructional interface for reviewing and annotating data to train a model.

FIG. 15 is a schematic illustration depicting an example instructional interface providing onboarding steps for initiating tasks or collecting data, including task attributes like object type, object position, and other setup parameters, with the interface indicating episode counts needed and ensuring all components are in the camera's field of view.

FIG. 16 is a further schematic illustration depicting an example instructional interface providing configuration instructions and recording setup parameters, including episode duration targets, starting positions, object specifications, and visual guidance to ensure proper camera field of view coverage for data collection.

FIGS. 17A-B are schematic illustrations depicting an example task detail page providing comprehensive guidance for task execution, including overview instructions, timing parameters, position variations, step-by-step movement guidance with visual aids, and a detailed attribute mapping showing possible starting positions and configuration options.

FIG. 18 is a schematic illustration depicting an example robotic arm with cameras around the robot for a 360-degree view to prevent collisions including when operating.

FIG. 19 is a schematic illustration depicting a front view of a handheld demonstration device, showing key components such as an exchangeable tool, sensing elements, and a camera arm.

FIG. 20 is a schematic illustration depicting a side view of the demonstration device, illustrating the arrangement of components including a mounting interface and adjustable position mount.

FIG. 21 is a schematic illustration depicting an exploded view of the demonstration device, illustrating how components such as a sensing device, mounting device, and exchangeable tool fit together.

FIG. 22 is a schematic illustration depicting an alternative exploded view of the demonstration device, highlighting variations in component arrangement and attachment points.

FIG. 23 shows an additional non-limiting example of a demonstration device with movable arms incorporating various sensors, including a mountable camera system with depth sensing capabilities, position encoders, pressure sensors, and grip force sensors. The device features interchangeable fingertip attachments for manipulation tasks.

FIG. 24 illustrates a non-limiting example of an additional configuration of the demonstration device that includes a force/torque sensor for enhanced force measurement capabilities.

FIG. 25 depicts a non-limiting example of a demonstration device having a finger grip configuration featuring a wrist strap design and specialized grip interfaces for manual manipulation and control.

FIG. 26 shows a further non-limiting example of a demonstration device equipped with a camera mounting arm designed to capture additional viewing angles.

FIG. 27 illustrates a non-limiting example of a gripper interface on a demonstration device featuring multiple grip surfaces designed for handling objects of varying sizes, including dedicated surfaces for large and small objects, plus a customizable gripping area.

FIG. 28 depicts a non-limiting example of the example components and sensor arrangement of the demonstration device, highlighting the integration of various feedback systems including rotary encoders, force sensors, and pressure sensors.

FIG. 29 shows a non-limiting example of an alternative perspective of the demonstration device's gripper assembly and sensor configuration.

FIG. 30 illustrates a non-limiting example of the demonstration device's mounting system, featuring an ISO-compatible pattern that can accommodate robotic mounting or human interface applications.

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

### DETAILED DESCRIPTION

The present disclosure relates to a combined hardware-software ecosystem that simplifies robotic arm setup, operation, and training. More specifically, the present disclosure describes various embodiments of robotic training systems, devices, and methods that enable intuitive demonstration and learning of robotic tasks.

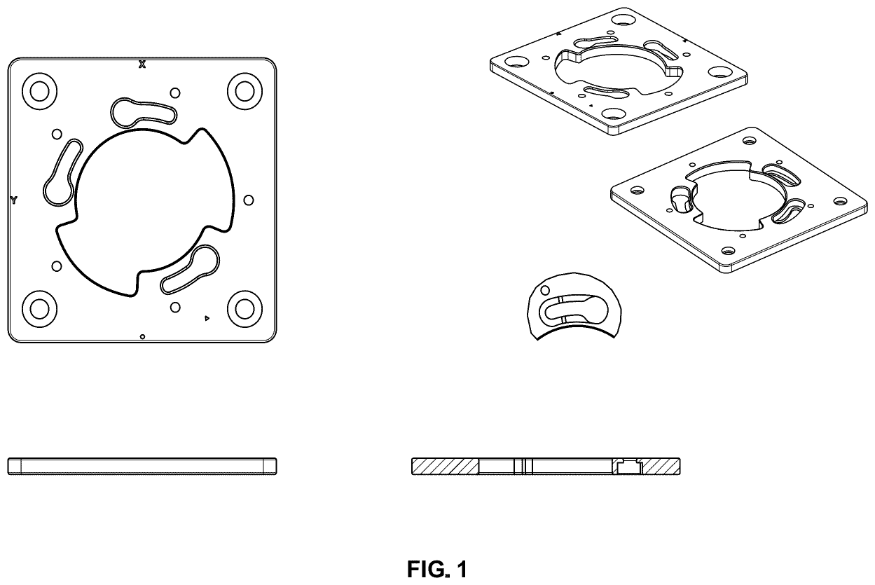

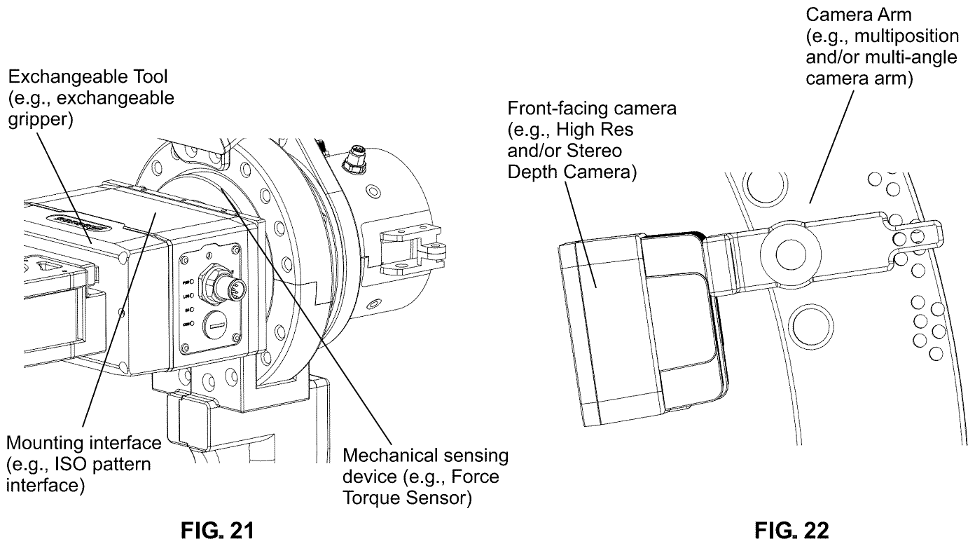

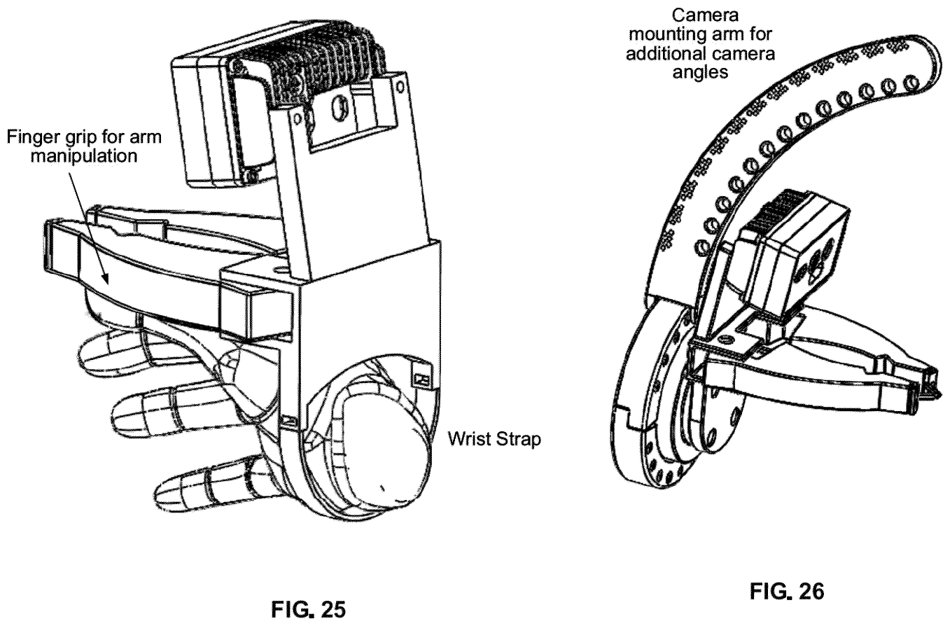

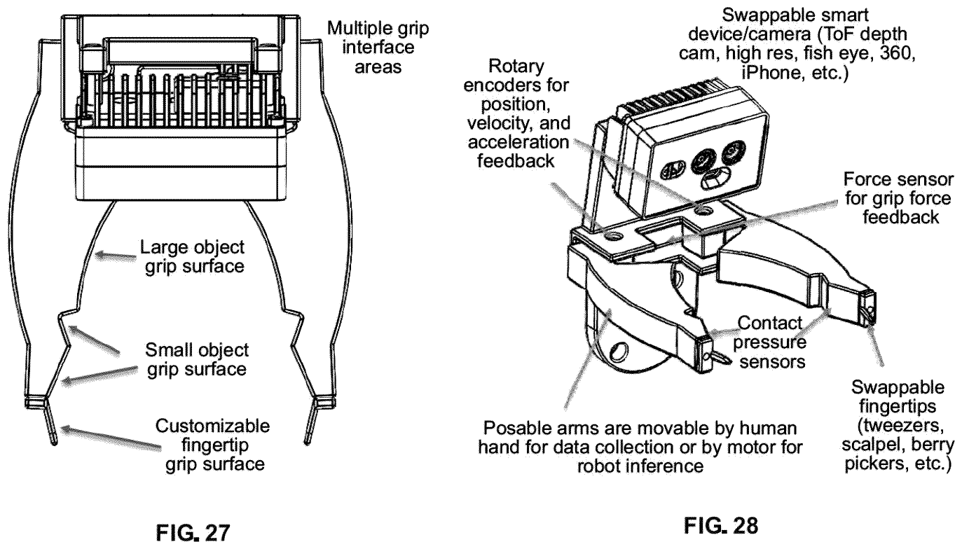

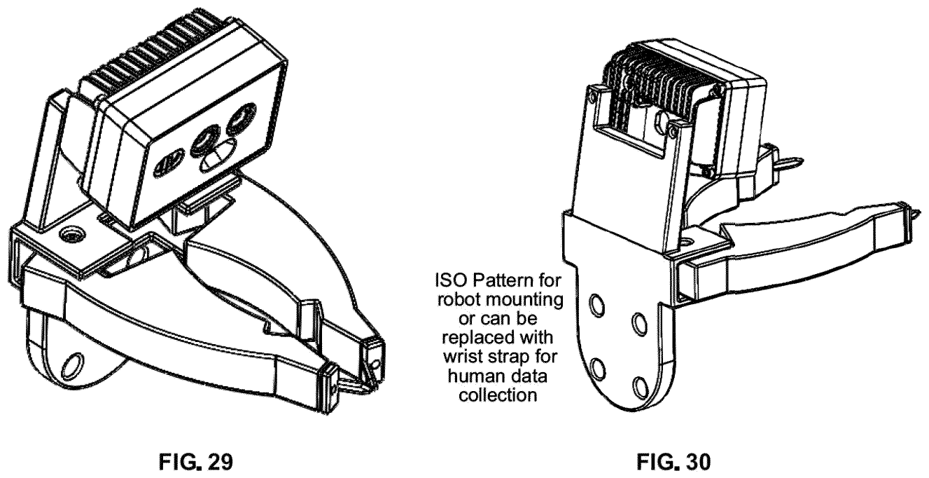

As shown and described, FIGS. 1-30 collectively illustrate a unified approach for reducing complexities associated with configuring and programming robotic arms. The systems described herein facilitate the capture and translation of human demonstrations into robot-executable actions through various sensing modalities and control interfaces. These embodiments may be implemented individually or in combination to create comprehensive robotic training solutions.

In one embodiment, a robotic training system comprises one or more leader robotic devices configured for human manipulation, and one or more follower robotic devices configured to replicate at least one movement of the one or more leader robotic devices, and one or more force sensors, torque sensors, or force-torque sensors on at least one of: the one or more leader robotic devices, one or more of the one or more follower robotic devices, or any combination thereof. The robotic training system is configured to process force data, torque data, or force-torque data measured by the one or more force sensors, torque sensors, or force-torque sensors among the one or more leader robotic devices and the one or more follower robotic devices, where the force data, torque data, or force-torque data corresponds to one or more physical actions performed by the robotic training system, and record the force data, torque data, or force-torque data as demonstration data, where the demonstration data is adapted for training of at least one artificial intelligence (AI) model, where the AI model is designed to train at least one robot to perform the one or more physical actions performed by the robotic training system.

In another embodiment, a robotic training system comprises one or more leader robotic devices configured for human manipulation, and one or more follower robotic devices configured to replicate at least one movement of the one or more leader robotic devices, one or more interchangeable electromechanical end effector tools mounted on at least one of: the one or more leader robotic devices, one or more of the follower robotic devices, or any combination thereof. The robotic training system is configured to process information corresponding to one or more physical actions performed using the one or more interchangeable electromechanical end effector tools among the one or more leader robotic devices and the one or more follower robotic devices, and record the one or more physical actions performed using the one or more interchangeable electromechanical end effector tools as demonstration data, where the demonstration data is adapted for training of at least one artificial intelligence (AI) model, where the AI model is designed to train at least one robot to perform the one or more physical actions performed by the robotic training system.

In another embodiment, a handheld device for robotic skill demonstration comprises a body portion configured to be manipulated by a user, and one or more force sensors, torque sensors, or force-torque sensors configured to measure force-torque data. The handheld device is configured to record the force data, torque data, or force-torque data as demonstration data, where the force-torque data corresponds to one or more physical actions performed by the user with the handheld device, and where the demonstration data is adapted for training of at least one artificial intelligence (AI) model, where the AI model is designed to train, using the force-torque data, at least one robot to perform the one or more physical actions demonstrated by the user.

In yet another embodiment, a handheld device for robotic skill demonstration comprises a body portion configured to be manipulated by a user, and a mounting interface configured to mount one or more interchangeable electromechanical end effector tools configured to be manipulated by the user. The handheld device is configured to record one or more physical actions performed by the user with the handheld device using the one or more interchangeable electromechanical end effector tools as demonstration data, and where the demonstration data is adapted for training of at least one artificial intelligence (AI) model, where the AI model is designed to train at least one robot to perform the one or more physical actions demonstrated by the user using the one or more interchangeable electromechanical end effector tools.

In a further embodiment, a robotic control system comprises a learned policy module trained from demonstration data, where the demonstration data comprises force data, torque data, or force-torque data corresponding to sensed interaction forces between a robot and a corresponding environment, and visual data corresponding to a vantage point of a user while performing one or more physical actions. A control module is configured to operate one or more robots using position control for trajectory following, operate one or more robots using force control for interaction tasks, and automatically transition between position control and force control during task execution based on sensed interaction forces between the one or more robots and an environment, and between outputs from the learned policy module indicating desired control modes. As used herein, the term “force control” includes control of forces, torques, both forces and torques (e.g., as force-torque data or using at least one force-torque sensor), or any combination thereof.

In another embodiment, a method for robot programming comprises receiving robot program steps; automatically generating natural language descriptions of robot actions for each step based on force data, torque data, or force-torque data corresponding to sensed interaction forces between a robot and a corresponding environment, and visual data corresponding to a vantage point of a user while performing one or more physical actions; and using the natural language descriptions, creating a human-readable narrative sequence of at least one robot program based on at least one of: robot configuration data, robot action parameters, or any combination thereof.

Some embodiments of the present disclosure relate to a bayonet mount system for easy and secure robot mounting, especially for heavier robots. This system simplifies alignment and attachment, removing the need for balancing the robot while screwing. For instance, FIG. 1 shows a bayonet mounting system that streamlines attachment between a robotic arm and its base. In another aspect, various embodiments describe a bayonet mount system configured to secure a robot to a base in an efficient and stable manner. This system utilizes a bayonet interface designed both to guide the robot into the correct orientation through mechanical keying and to support the robot's weight once the mount is partially rotated from an insertion position to a locked position.

By aligning the robot and base at the correct angle, the user can insert the robot vertically without needing to balance its full weight. As soon as the partial rotation begins, the bayonet interface bears most of the load, allowing the user to complete the twist until the system achieves a secure, locked alignment. The bayonet mechanism ensures that once engaged, the robot remains steadily anchored, mitigating the risks associated with traditional mounting methods that require manually threading screws to secure large and heavy robotic equipment.

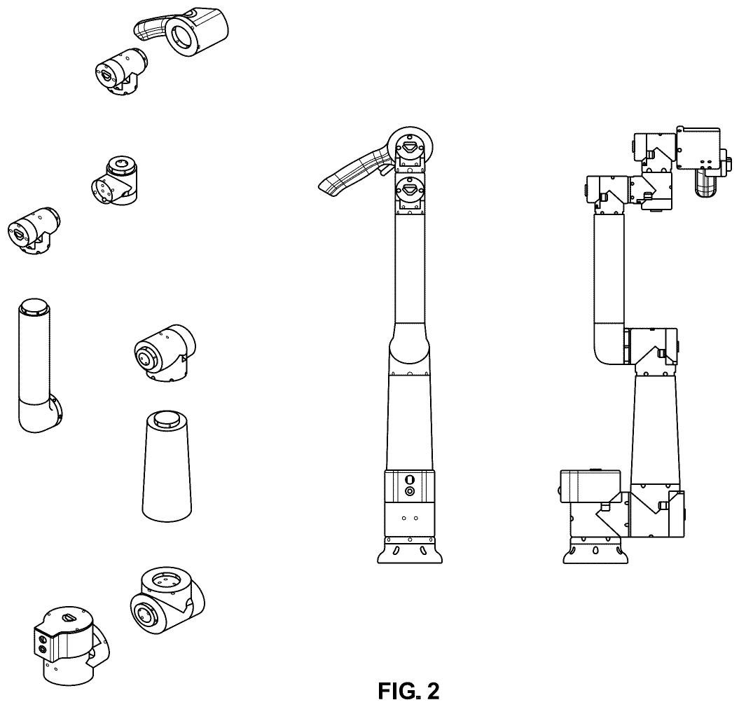

Furthermore, the disclosure presents a user-friendly interface for integrating third-party accessories like stack lights and conveyor belts with robots. This intuitive, plug-and-play-style system is designed for easy use, even by those without technical expertise. For example, FIGS. 2-5 depict robotic arms arranged for the training methods discussed here.

Some embodiments of the present disclosure also include one or more teleoperated leader robotic arms equipped with fixed or configurable physical or on-screen buttons for common real-time programming controls during kinesthetic guiding of one or more other robotic follower arms, as described throughout the present disclosure. For instance, FIGS. 6-8 describe various positional and support embodiments, including examples of wearable systems, including example demonstration devices, designed to reduce user strain and enhance precision. Some embodiments of the disclosure further address the issue of external hardware by integrating miniature cameras directly into robot joints. These cameras, powered by internal wiring, provide extensive coverage of the working area from various angles, ensuring maximal visibility with minimal additional hardware.

Some embodiments of the present disclosure outline a robot programming interface that incorporates language models and environmental scanning. This interface automatically creates detailed narratives for each programming step, elucidating the robot's actions and settings. These narratives are formed from a mix of user inputs, environmental scans, and object recognition, offering an accessible robot programming method. For example, FIGS. 9-17B focus on user interfaces and step-by-step workflows guiding project setup, data labeling, and demonstration-based training processes. The disclosure also describes a secure user authentication system for robot operation. The system utilizes biometric and facial recognition technologies on mobile devices or connected cameras, offering a more secure and convenient alternative to traditional password systems.

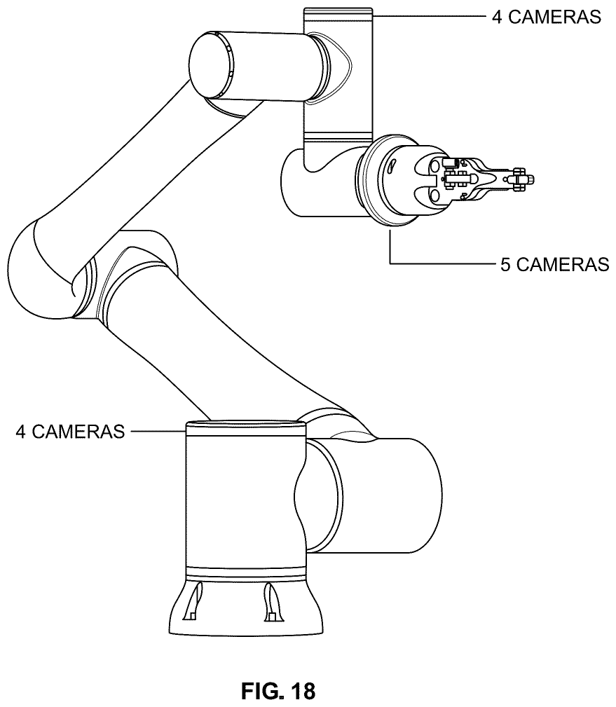

FIG. 18 depicts a schematic illustration depicting an example robotic arm with cameras around the robot for a 360-degree view to prevent collisions including when operating.

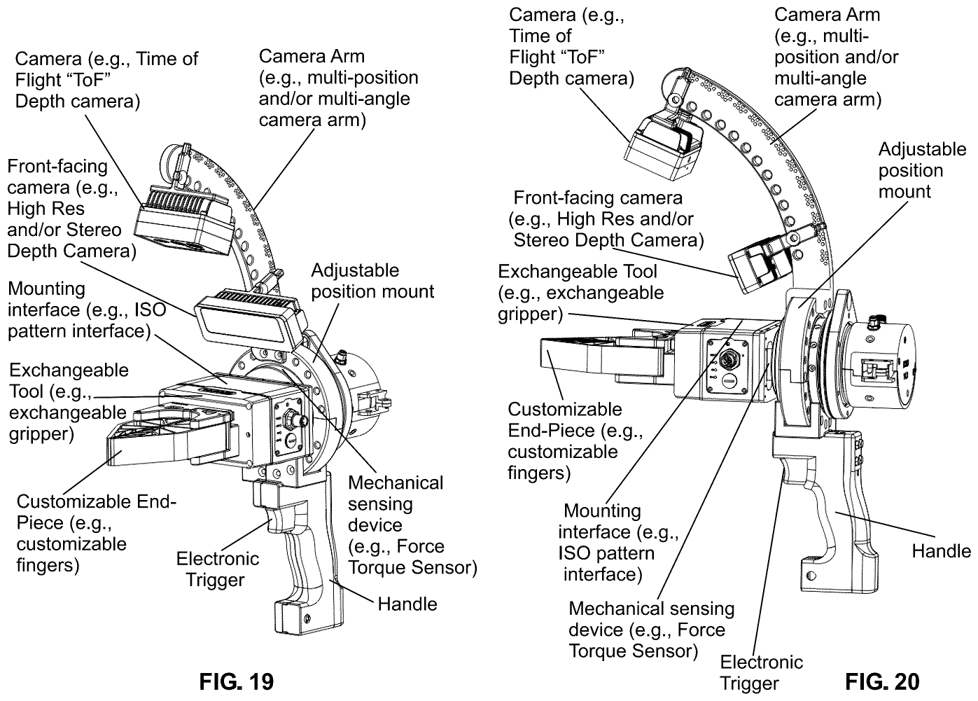

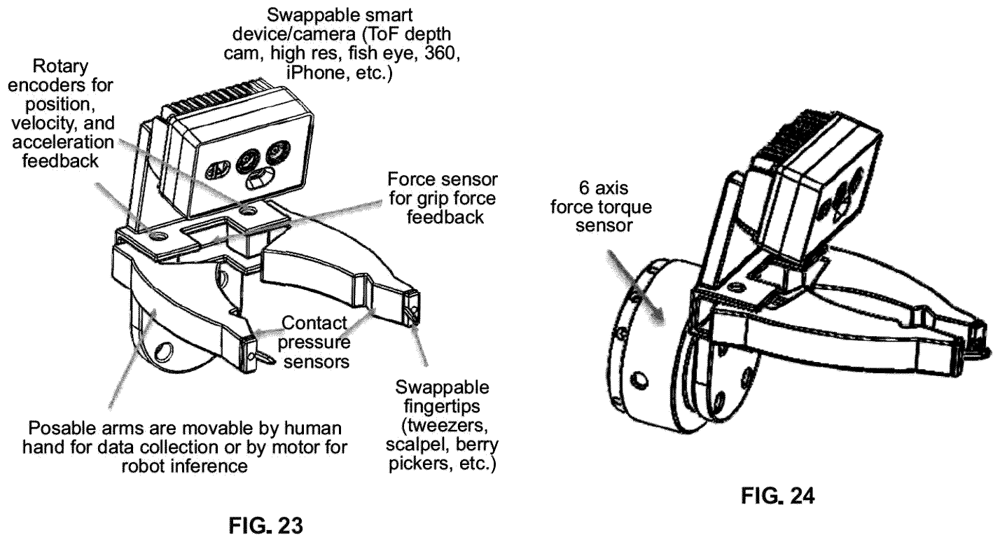

FIGS. 19-22 offer front, side, and exploded views of a handheld demonstration device equipped with sensing components, mounting interfaces, and camera arms to capture depth data, force measurements, and other key parameters for robotic learning. FIGS. 23-30 provide non-limiting examples of various demonstration device configurations, including detailed illustrations of sensor integration, grip interfaces, camera mounting options, and modular components designed to capture depth data, force measurements, and other key parameters for robotic learning. These figures showcase different aspects of the device's versatility, from its interchangeable fingertip system to its adaptable mounting configurations for both robotic and human interface applications.

By integrating these mechanical innovations with software-driven training interfaces, the present disclosure also supports a wearable-technology-based approach. In such an approach, a user can directly demonstrate tasks to a robot by wearing specialized devices or suits, leading to more intuitive skill acquisition. This cohesive framework reduces installation hurdles and makes the overall deployment of robotic arms significantly more accessible.

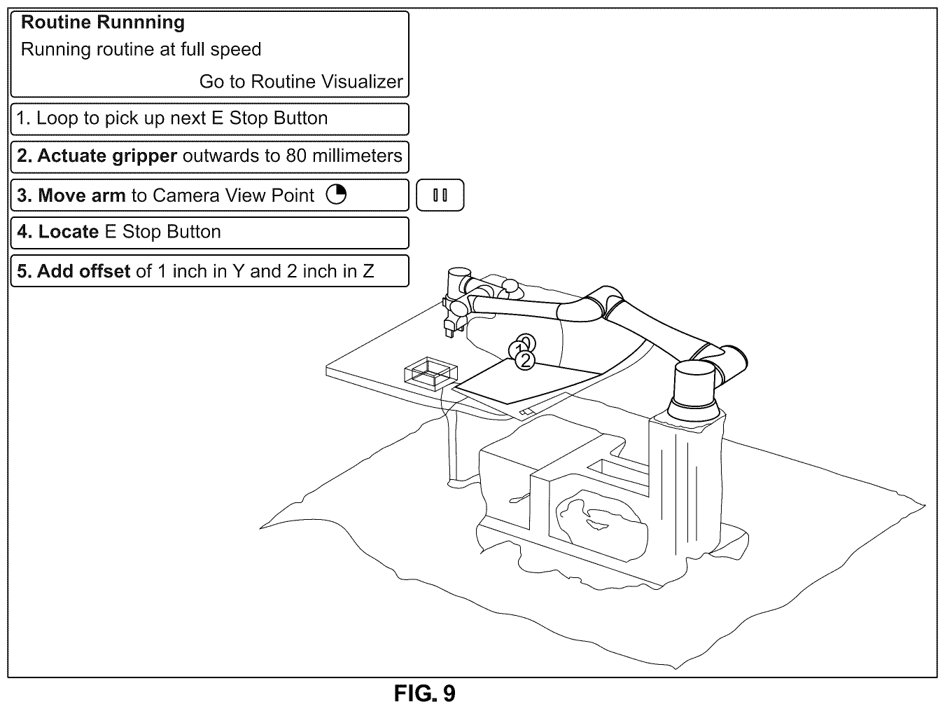

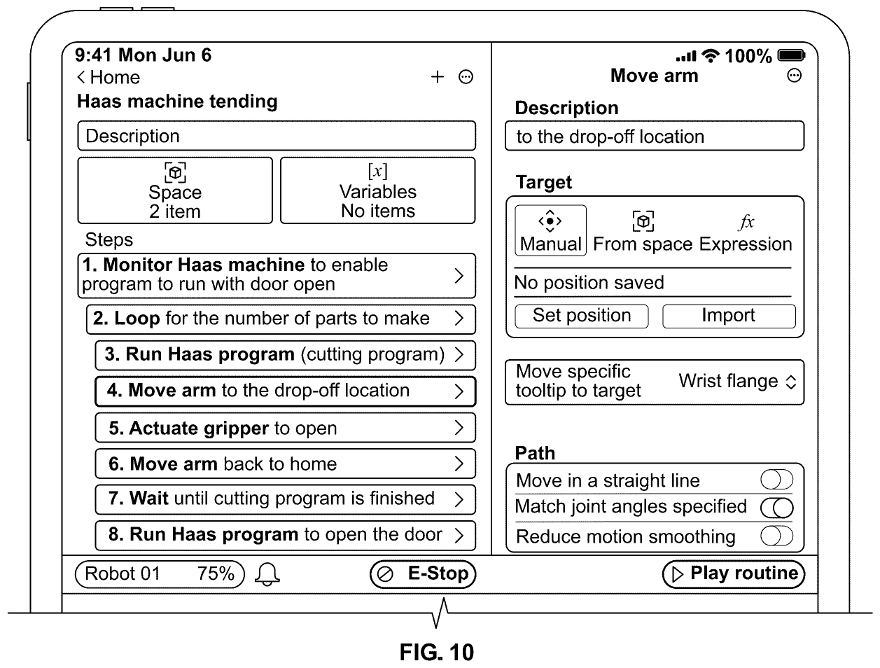

Some embodiments of the present disclosure relate to a robot programming interface that incorporates language models and environmental scanning. As shown, for example, in FIG. 10, one example interface can generate descriptive narratives for each step in a robot's program. These descriptions can be formulated based on the symbolic representation of the step and can vary from simple phrases like “loop forever” to more complex narratives describing movements towards specific objects or locations identified in a 3D space editor.

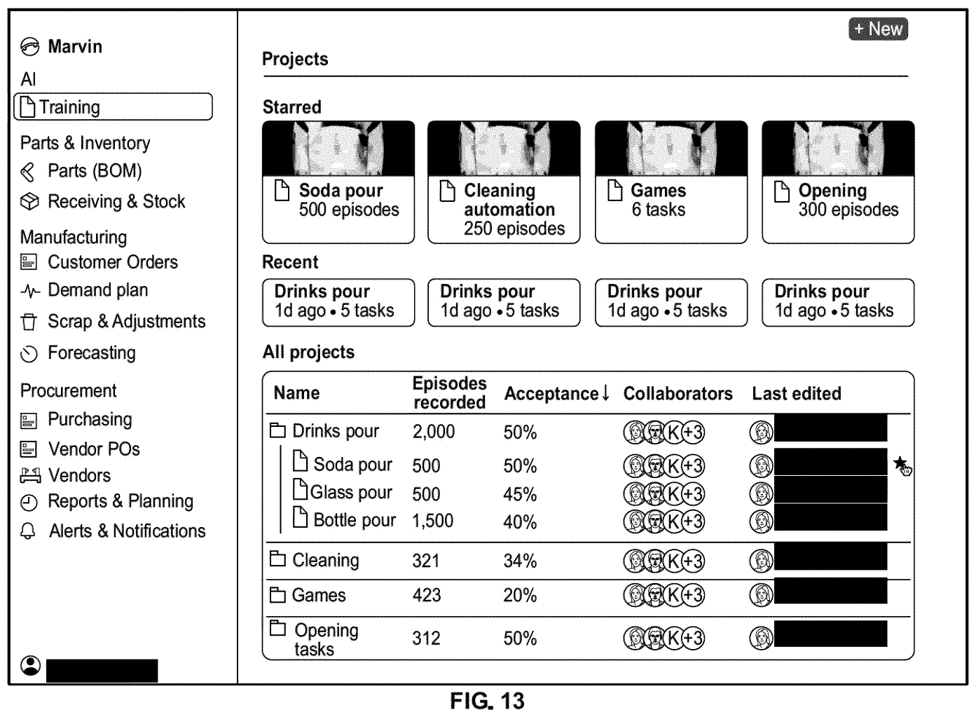

In certain examples, including the example of FIG. 13, the robot can employ environmental scanning and neural networks to recognize objects in the vicinity. This feature can allow the system to automatically label programming steps based on the robot's interaction with its environment, such as moving near a computer numerical control (“CNC”) mill or picking parts from a table, and to auto-generate programming steps (i.e., to know where to move the arm to if a user says “pick up the objects off the table and place them into the vice”).

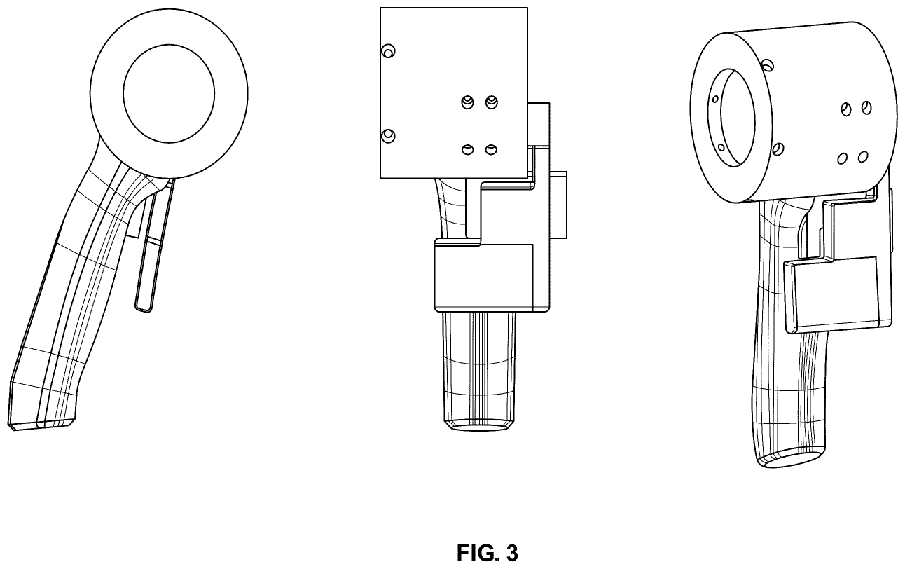

Note that the present disclosure uses the term “arm” throughout the text. The use of “arm” is not intended to be limiting and can apply to any type of robotic limb, such as but not limited to, robotic arms, robotic digits, robotic legs, robotic feet, among others as depicted in FIGS. 2 and 3.

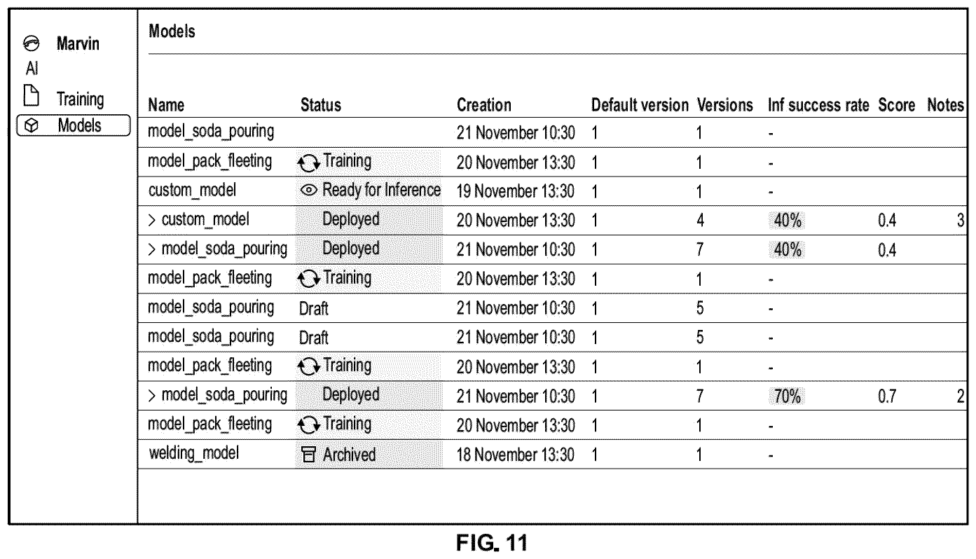

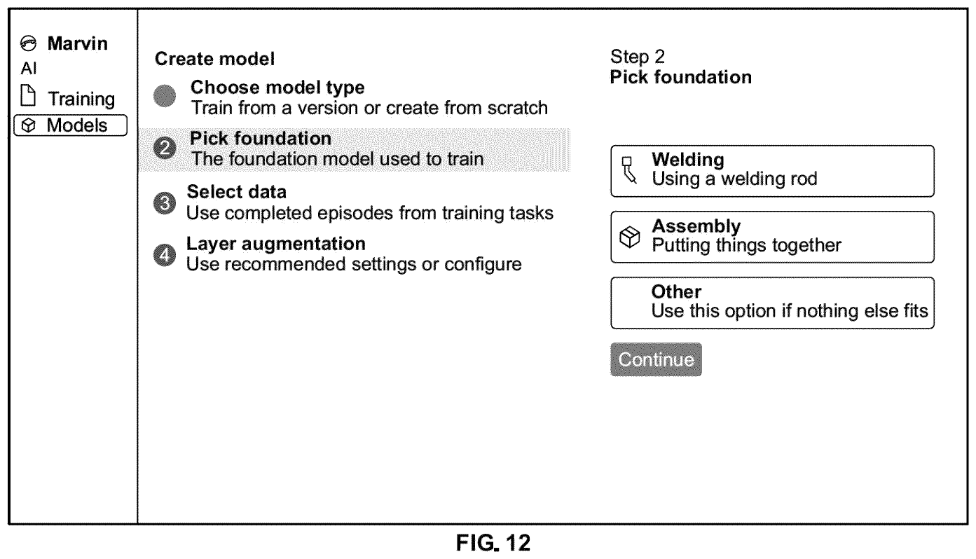

In certain embodiments, such as the embodiment of FIGS. 11-12, the system can use large language models (LLMs) to interpret natural language inputs from the user, enabling program modifications or creation through conversational commands. This feature simplifies the programming process, allowing users without prior programming knowledge to effectively communicate their intentions to the robot. The LLMs may request images or engage in interactive training sessions to better understand the user's intentions. This can involve recognizing specific equipment, such as a Haas VF2 mill, and suggesting appropriate fixturing based on a part's image.

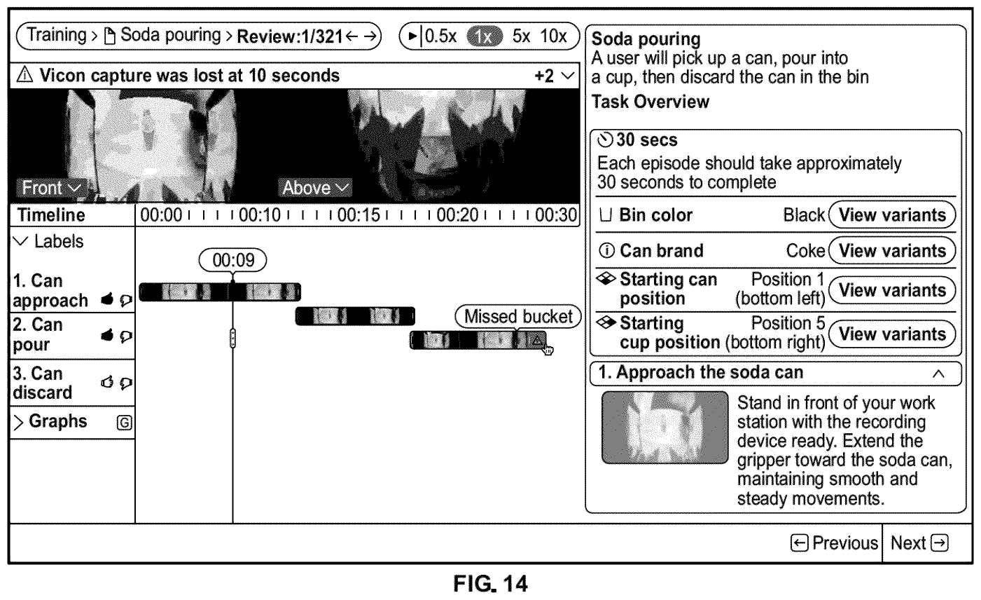

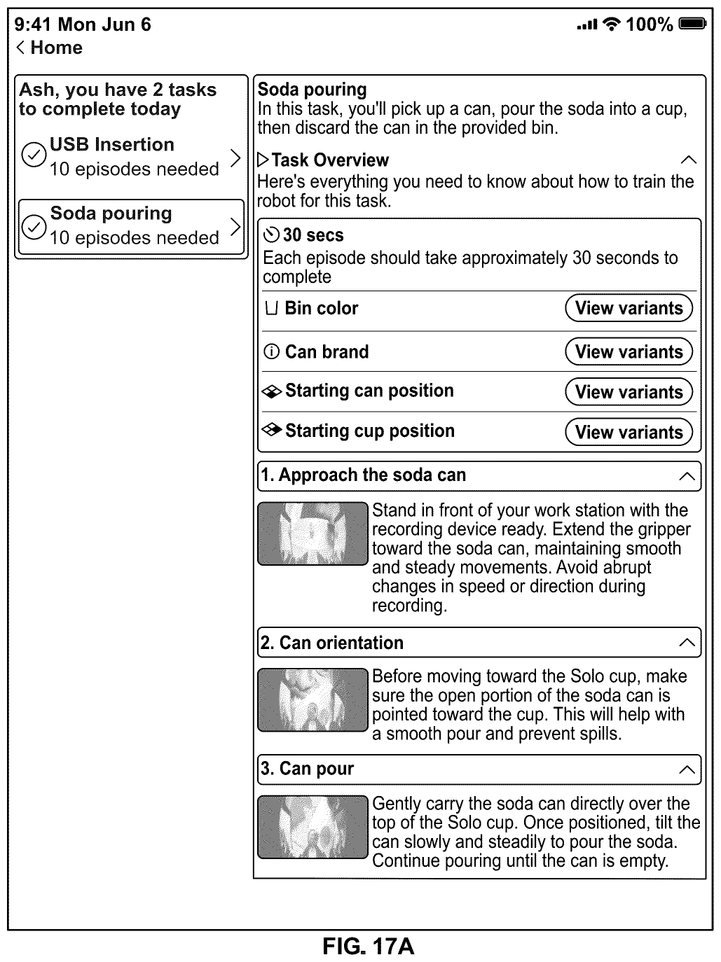

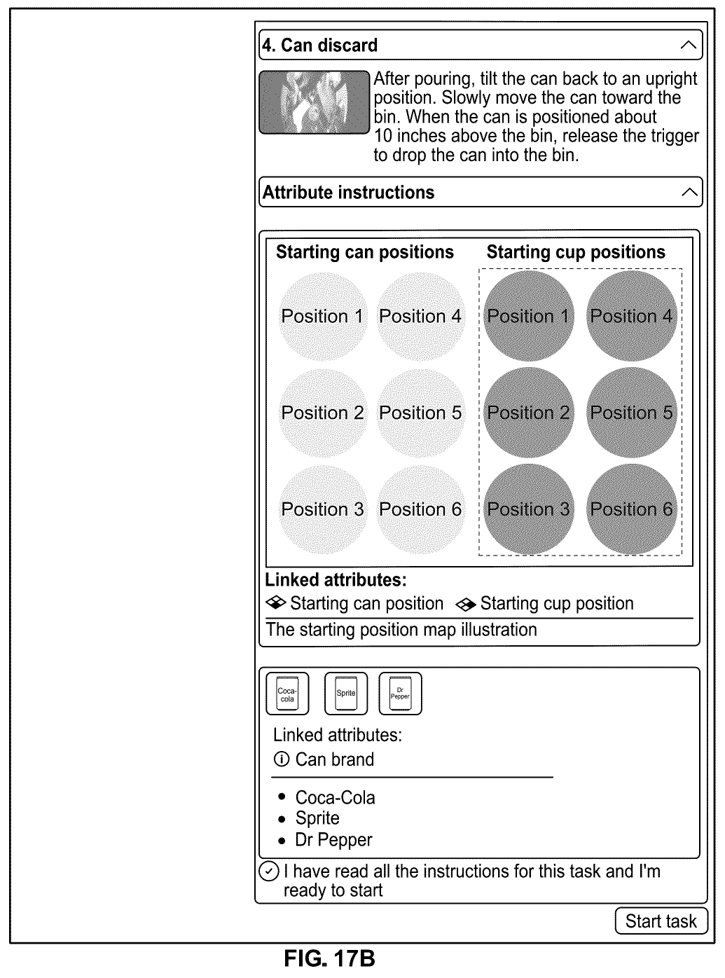

In certain implementations, based on user commands and environmental understanding, the system can autonomously generate, modify and optimize robot routines, including determining approach and departure points, setting speeds, and configuring equipment. See, for example, FIG. 14 and FIGS. 17A-B. For example, the system can utilize AI models to automatically complete certain steps outlined in the narrative sequences. For repetitive processes that follow predefined patterns, such as pick-and-place tasks, dispensing jobs, etc., the story generation module identifies these candidate hand-offs. It then prompts the user to train a new model or invokes pre-trained models to insert appropriate grip trajectories, pour pathways based on source/target geometries, and other parametric sub-routines to accomplish that high-level step. This leverages existing AI capabilities to simplify programming.

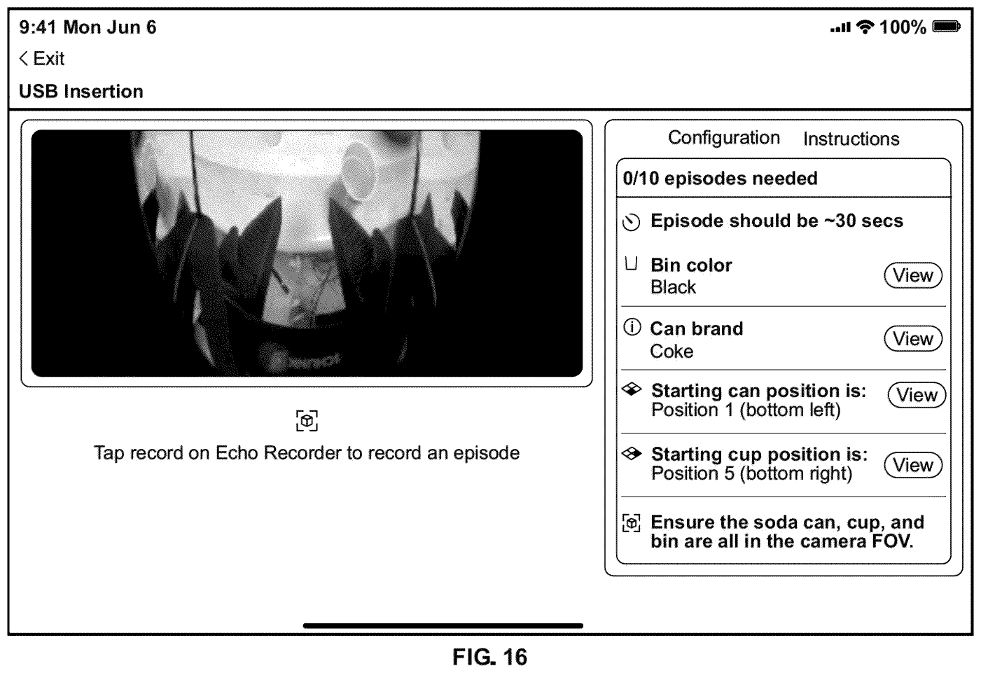

Another aim of the disclosure is the ability to synchronize the movement of a robot's tooltip with the movement of a mobile device. Accordingly, some embodiments of the disclosure introduce a novel technique for controlling a robot's tooltip via a mobile device like an iPhone or iPad. This method utilizes the device's cameras and APIs to align the tooltip's movements with those of the mobile device. As shown, for example in FIG. 16, when a user moves their device (e.g., an inch forward), the tooltip mirrors this movement in real-time. To effectively sync the movements, the system first determines the orientation of the mobile device relative to the robot. Orientation can be achieved through a manual input (rotating a visualization of the robot on the screen of a mobile device to match the physical robot orientation), a button press indicating the user is facing the robot (with a compass in each) or automatically by detecting the mobile device or person holding it from one of the robot's cameras.

In some examples, the system can offer a feature to adjust the scale of movement translation between the mobile device and the robot's tooltip. See, for example, FIG. 9. This allows for precise control, enabling both larger and smaller movements relative to the device's motion. This method provides users with an intuitive and direct way to control the robot's tooltip, enhancing dexterity and precision in its operations. The system may also leverage biometric authentication methods, such as Face ID or fingerprint scanning, available on a user's mobile device to validate their identity and grant access to specific robot operating modes. Alternatively, the system can utilize a camera integrated with the robot or a standalone camera connected to the robot for facial recognition, authenticating users based on their facial features. Upon successful authentication, the user is granted permission to switch between different operating modes of the robot, such as editing safety settings or modifying the robot's program, as defined in international standards like ISO 10218-1. By replacing traditional PIN or passcode systems, the disclosure not only streamlines the process of mode switching for authorized operators but also enhances security by minimizing the risk of passcode sharing or exposure. The use of biometric and facial recognition for authentication also improves the safety of robot operations by ensuring only authorized personnel can make critical changes to the robot's settings.

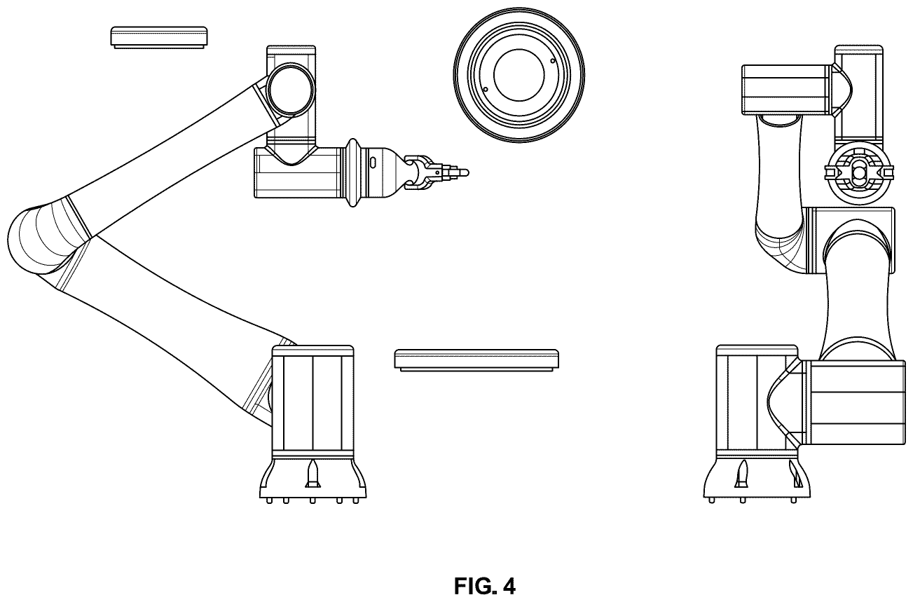

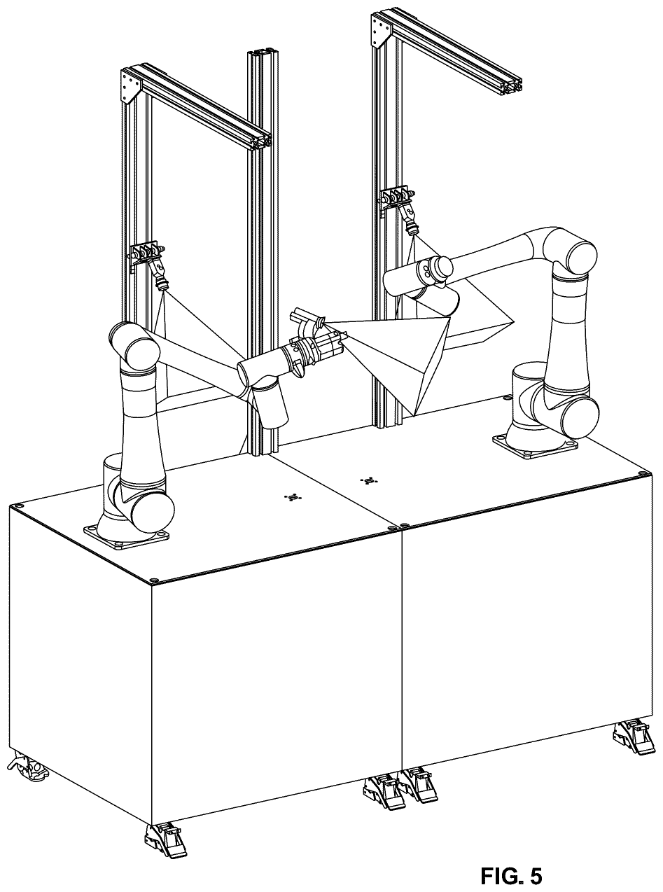

Some embodiments of the present disclosure relate to enhancing robot reliability and lifespan by connecting the robots to the internet for log analysis. This analysis helps in preemptive maintenance and identifying usage patterns that could lead to early failure. For instance, the robots, non-limiting examples of which are shown in at least FIGS. 4-5 & 18, may be equipped with internet connectivity to transmit operational data logs to a centralized analysis system. The collected data is analyzed to identify anomalies in robot performance, which can trigger preventative maintenance actions to avoid unplanned downtime. The system monitors various indicators such as torque ripple, torque disturbances over time from expected torques, motor and gear unit temperatures, and control box conditions. This monitoring is conducted at regular intervals to track changes in performance. Inertial Measurement Unit (“IMU”) data can be collected to detect any unusual shaking or instability in the robot's operation, which could indicate potential issues.

In some examples, the system can also collect and analyze waveforms related to the commutation of the robot's motor, providing insights into the electrical performance and health of the motor. By analyzing this comprehensive data, the disclosure aims to significantly enhance the reliability of robots, reducing downtime and associated costs for factories and automation lines by detecting when performance starts to degrade, what the source of the decay is (e.g., wearing gear units), and when maintenance or replacement is necessary.

Certain examples of the present disclosure relate to a bayonet mount that connects the robot to its base. One non-limiting example is shown in FIG. 1. This mechanism enables the user to align the robot with the base using visual features and then twist the robot relative to the base to secure it in place. Once the robot is secured through the bayonet mount, screws are used to further stabilize the connection. The design includes a pattern of holes on the base that align with screws protruding from the bottom of the robot. As the robot is twisted into position, the holes in the base, initially large enough to accommodate the screws, become smaller, effectively locking the screws in place, and preventing the robot from being easily detached. This mounting system significantly reduces the difficulty of installing heavy robots, eliminating the need to balance the robot's weight while being secured with screws. The bayonet mount can also include visual indicators to assist users in properly aligning the robot with the base before being secured.

The system can also utilize pre-crimped connectors for third-party accessories, which are prepared before being sent to the user. This approach minimizes the need for the user to crimp screw terminals, reducing the risk of incorrect installations. Screw terminals can be clearly labeled, facilitating easy and error-free connection by the user. The labels correspond to different types of connections needed by various accessories. Once an accessory is connected, the user selects the corresponding terminal block in the robot's user interface. See, for example, FIG. 9. This selection ensures that the robot correctly identifies and integrates the connected accessory. In some embodiments, the system features a single connector that includes General Purpose Input/Output (GPIO) pins, inputs, outputs, 24-volt IO, and ground connections. This design simplifies the connection process and allows for a wide range of accessories to be easily integrated. By simplifying the connection process and reducing the need for manual wiring, the disclosure significantly lowers the risk of damage to both the robot and the connected accessories.

A non-limiting system for more intuitive robot programming and training using at least one teleoperated leader robotic device in the form of at least one leader arm is also described. The system can include one or more leader robotic arms (which may, in some embodiments, be smaller than the follower arms described below) that can be held and teleoperated by a user. The movements of the leader arms are mapped in real-time to control at least one teleoperated follower robotic device in the form of one or more follower robotic arms (which may, in some embodiments, be larger than the follower arms described above). This allows the user to kinesthetically demonstrate tasks, trajectories, and skills for the follower arm in an intuitive way using their own dexterity. The system can have a user interface display to start/stop teleoperation, display arm positions, sync the arms, adjust control ratios for fine movements, and record demonstrations. At least one leader robotic arm may have configurable buttons for common controls like start/stop recording. Voice commands are also supported for hands-free control.

FIGS. 6-7, and 19-30 show non-limiting examples of demonstration devices, which may be present on a smaller leader arm. As shown, the smaller leader arms incorporate active gravity compensation which allows the lightweight arms to move nearly free of gravity influence. Motors on the arm joints apply dynamic counter-torque to produce an “antigravity” effect, eliminating most of the weight and inertia the user feels. This antigravity mode, commonly referred to as “freedrive” on many robotic arms, allows a user to maneuver the leader arms effortlessly as needed for intuitive teaching. Minimizing gravitational loading allows finer motoric control unimpeded by arm weight in guiding motions. It also keeps the arm steady when releasing an arm grip so the arm does not swing or drift unexpectedly under its own weight.

Further, the adjustable gravity compensation provides configurable force feedback to the user as they operate the leader robotic device. Compensation levels can be dialed to let the user feel inertia when moving too quickly or approaching safety thresholds. This provides intuitive speed and safety feedback valuable during the demonstration process without impeding overall lightweight freedrive behavior. Integrating tunable freedrive settings creates an agile, stabilized leader arm platform with force and safety awareness-enabling dexterous yet controlled demonstration workflows aiding teach-by-guidance programming. The system continually monitors freedrive statuses across both leader and follower arms to synchronize and gracefully adjust forces as needed in the programming environment.

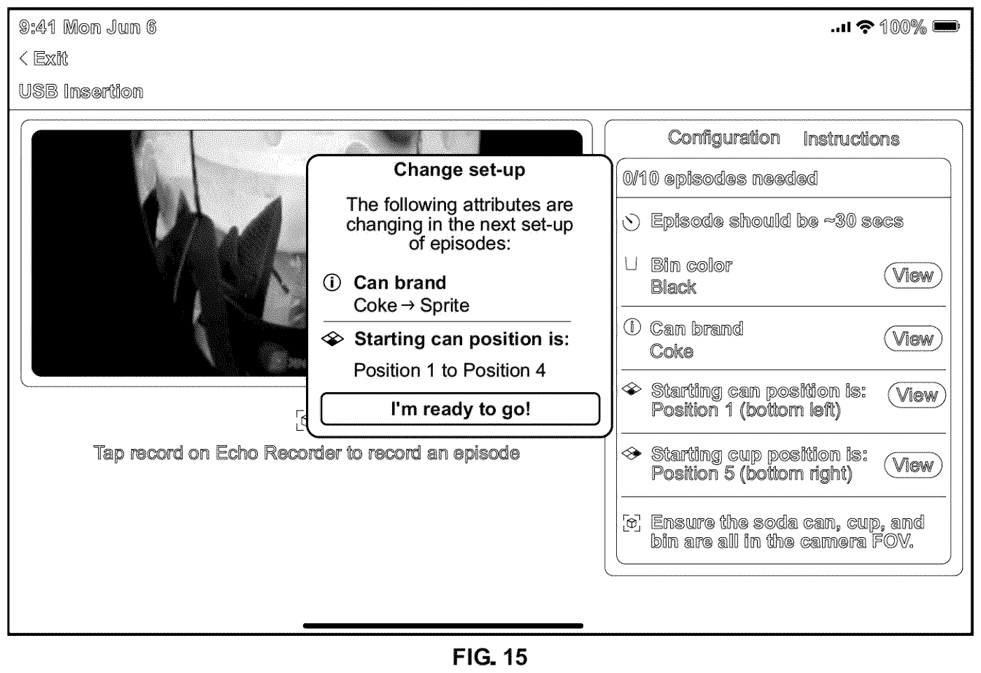

To aid skill building, a system, such as that shown in FIG. 15, can guide the user during demonstrations using past recordings and models, e.g. for peg insertion. Haptic feedback on the arms and triggers helps the user feel forces and resist movements nearing safety limits. Antigravity modes on the leader arms keep them lightweight and synchronized.

A leader arm gripper mechanism shown in Referring to FIGS. 6, 7, 19, 20, and 23-30 can also be equipped with an integrated multifunction trigger device designed for flexible grasping control. This dual-mode trigger allows the user to control grip strength through either a traditional finger-pulling trigger motion, or an alternative pinch control by bringing the thumb/forefinger together mimicking the gripper's close action.

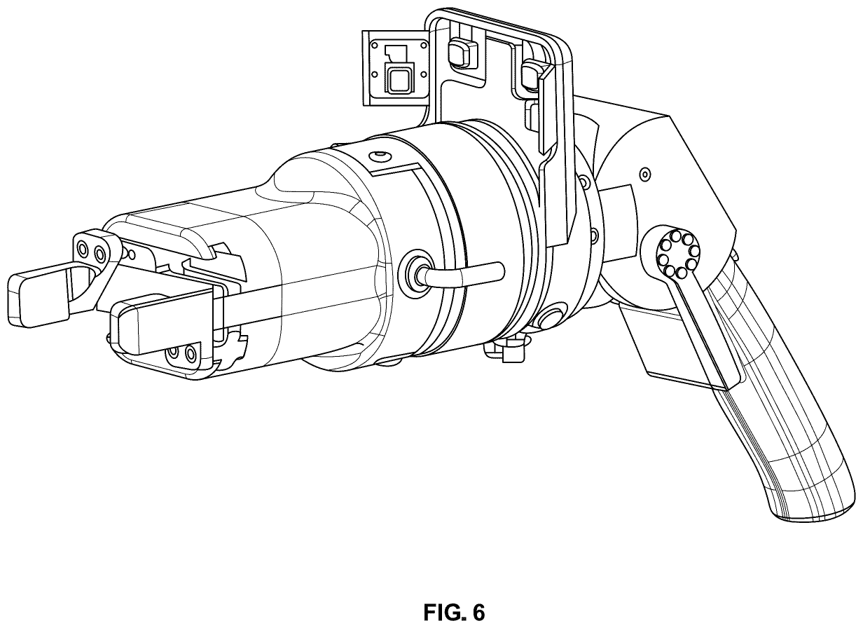

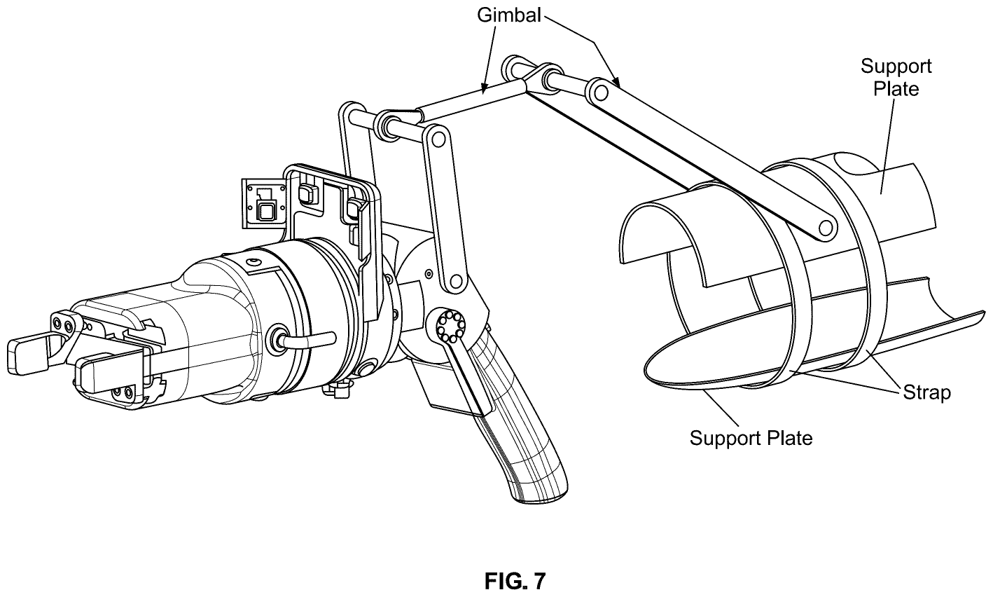

An adjustable “L” shape frame, see, e.g., FIG. 7, allows for ergonomic access to operate a trigger (shown, for instance, in FIGS. 19-20) in either mode. Enabling both pulling and pinching control modes provides flexibility matching a variety of grip styles and object handling scenarios required in programming demonstrations. The intuitive pinching control in particular helps mentally map the leader arm's end effector control to the follower arm's gripper.

The system also provides the capability to integrate augmented reality (AR) or virtual reality (VR) headsets with the leader arm programming process to enable more intuitive visualization and control. Rather than relying on a standard robot teach pendant, the user can wear an AR/VR headset that displays real-time video feeds from the follower arms stereo camera setup, overlaid with operational data. In certain examples, the follower arms are equipped with multiple cameras, with two cameras optionally mounted in proximity to some locations to provide realistic 3D stereo views through an AR headset. Video feeds from this stereo camera setup are delivered separately to each eye in the AR/VR headset, creating a 3D stereoscopic view for the user. This allows the user to perceive depth as they observe the robot workspace dynamically in 3D as they provide leader arm demonstrations.

In some embodiments, the system also includes integrated success detection capabilities to automatically analyze demonstrations and identify viable recordings for follower arm programming. See, e.g., FIGS. 13-16.

Custom artificial intelligence models including convolutional neural networks (CNNs) can be trained on labeled arm and task movement datasets to recognize key positional, force and other performance metrics in new demonstration recordings. The models inspect specific programmed criteria in the recordings related to expected timings, trajectories, collision avoidances, force applications, hardware statuses, and other metrics. Demonstrations meeting predefined metric thresholds are saved as quality viable examples for training follower arm AI or programming workflows. Outlier recordings are automatically filtered out from queues without human review to accelerate programming.

Additional capabilities include connecting remote operators, seeding simulators with real-world demos, and automated success detection to review recordings.

In some examples, rotational joints can include one or more outward facing cameras with fully integrated wiring, enabling up to 360° visualization without risk of occlusion. See, e.g., FIG. 18. This decentralized arrangement ensures critical surfaces, tools, and gripper interactions can be fully observed during demonstrations from the configurable on-arm perspectives, eliminating blind spots. By reducing setup complexity, construction time, and calibration risks compared to fixed external cameras, while still delivering the requisite variety of visual demonstration data needed for AI, the disclosure provides superior ease-of-use and flexibility for training. Algorithms dynamically choose camera properties during demonstrations, including triggering autofocus on key objects, and setting per-camera frame rates/resolutions to balance detail and bus bandwidth.

Robots may work on interconnected table sections, optimally spaced for reach and stability. As robots are moved together, a software prompt assists joint multi-arm programming. The distributed cameras can identify objects of interest in their frame and communicate this to peer cameras. A coordinated handoff routine shifts object tracking and triggering responsibilities between cameras as arms move. This maintains consistent in-focus visualization of items being manipulated without requiring external processing. To prevent overloading communications buses, individual cameras make local resolution, compression, and frame rate selections based on presence of noteworthy elements, background complexity, and system resource availability. Alternatively, a central coordinator agent assesses individual camera scenes and sets streaming policies balancing detail and data quantity. With visibility across all sides at each joint, arm movements can be halted when scenes exhibit signs of impending collisions with objects or humans. Rapid occlusion onset also acts as a trigger, employing camera failures as safety mechanisms per established functional safety methodology. Modular table sections featuring integrated power, networking, and precise mounting connections allow reconfiguration into larger platforms. Robots detect proximate table mergers and initiate a multi-arm programming mode with unified visualization and control for efficient collaborative setup.

This disclosure further relates to robotic control systems, and more specifically to techniques for automatically generating demonstration data for robots in simulation to enable robust learning of manipulation skills. The system can include a scanning module that captures 3D scans of real-world robotic setups and environments and objects to be manipulated. Textures and lighting conditions may also be captured.

A simulation generation module can be included that creates simulated environments in one or more physics engines based on the scans. The module provides interfaces for specifying variability and alternate conditions to generate additional demonstrations. This includes changing textures, lighting, object poses, adding simulated noise/errors, etc. A data collection module can be included that leverages reinforcement learning and other algorithms to generate a wide range of demonstration data by attempting tasks in simulation under different conditions. Adversarial techniques may add intelligent noise. Failed demonstrations are sent back to simulation generation to produce additional training under those conditions. A training module can aggregate simulation demonstration data, measures variability coverage, and can request additional data from simulation for underrepresented concepts. This data is used to train neural network controllers for robotic manipulation. Reward models can be incorporated to simulate desired behavior qualities and constrain exploration to efficient, collision-free trajectories during data collection.

Potential advantages include faster and lower-cost generation of training data to enable learning robust manipulation skills that reliably translate to real robotic platforms across variability. Diffusion-based generative models have shown promise for synthesizing robotic demonstration data in simulation. However, generating robust real-world demonstrations requires accurately capturing physical environments and variability. To enable simulation of real-world conditions, the system first scans physical setups using depth cameras positioned on the robot's wrist. As the arm moves, it determines collision-free spaces and incrementally scans environments without risk of collision. Captured depth data is integrated using Gaussian splatting based on known camera poses to reconstruct 3D scenes. Textures, lighting conditions, and camera calibration parameters are also captured.

Synthesized demonstrations can be produced by large multimodal generative models based on LLava1.5, a neural-network language model architecture. However, other suitable models can be used. Adversarial techniques and noise are used to induce failures and expand distributional coverage during diffusion-based data generation. The model is first pretrained on human teleoperation demonstrations showing successful task completions. Additional demonstrations are then generated by iterating the following process: Simulation environments are constructed from scanned scene data and calibrated camera models; photorealistic rendering adds natural lighting and textures; the generative model creates demonstration rollouts by attempting tasks under simulated conditions; adversarial techniques and noise are used to induce failures and expand distributional coverage. Failed rollouts are sent back to simulation generation to produce additional demonstrations under those conditions. Success criteria and reward models further guide generation; over multiple generations, demonstration complexity increases by varying object poses, lighting, textures, and introducing edge cases via generative networks. This pushes the model to expand its understanding and exhibit more resilient behavior.

The system may leverage reinforcement learning from human feedback (RLHF) to automatically rate demonstration performance in simulation. Diffusion generative models may add randomness and noise to expand distributional coverage.

Demonstration complexity increases gradually by iterating over generations of data. In each generation, variability is expanded along user-specified axes by perturbing factors like camera angles and object locations. The model attempts tasks under these conditions. When unsuccessful, more demonstrations are synthesized via diffusion models before proceeding.

The reward model neural networks identify trajectory qualities like efficiency, collisions, and goal achievement. These models guide exploration to optimal paths during data generation. The teacher-student models can distill strategies from noisy demonstrations into refined policies in fewer iterations. The foundational models can encode generally desired behavior prior to simulation-based training, such as pausing when humans are nearby. Real-world demonstrations can also be incrementally added to simulation and used to retrain policies, accounting for additional variability.

By leveraging simulation combined with iterative generation from multimodal models, the system aims to create versatile robotic demonstration data at scale for acquiring robust manipulation skills. The resulting policies could be deployed on physical systems to handle real-world variability. A neural network controller outputs real-time control commands to a robot to complete full tasks or subtask skills. Skills demonstrated by the user are saved as reusable model steps that can be interleaved with classical programming logic. The system features automatic outlier detection and guided data expansion to improve model resilience. Resolution and model size adapt based on task complexity. Preconditions constrain skill execution context. Embodiment variations cover additional axes control, sensor integration, compute deployment, and skill sharing.

A robot control network (“RCN”) can be used in accordance with some embodiments of the present disclosure. A RCN is defined as a neural network controller outputting real-time control commands to a robot to complete full tasks or subtask skills, the neural network controller trained by demonstrations. The RCN can output real-time control commands to a robot to complete full tasks or subtask skills. Skills demonstrated by the user are saved as reusable model steps that can be interleaved with classical programming logic. The system features automatic outlier detection and guided data expansion to improve model resilience. Resolution and model size adapt based on task complexity. Preconditions constrain skill execution context. Variations also cover additional axes control, sensor integration, compute deployment, and skill sharing.

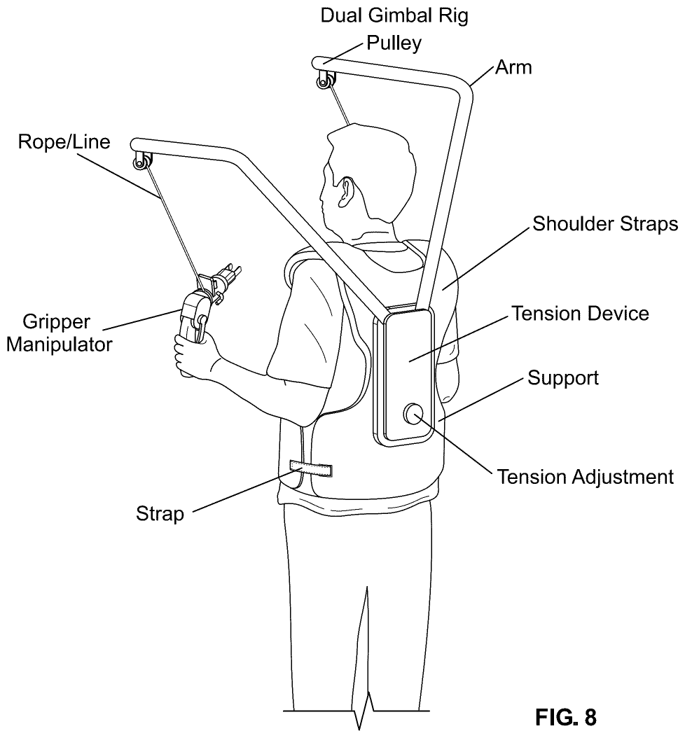

The present disclosure further includes the use of wearable technology to facilitate training of a robot in accordance with the present disclosure. One embodiment of wearable technology could comprise a demonstration suit (see, e.g., FIG. 8), comprising one or more demonstration limbs, such as but not limited to, a demonstration arm (see, e.g., FIGS. 6-7 and 19-30). The demonstration arm is defined as a system that includes one or more teleoperated leader robotic arms. These leader arms are equipped with either fixed or configurable physical or on-screen buttons. These buttons are specifically designed for common real-time programming controls that are used during the kinesthetic guiding of one or more robotic follower arms.

In certain examples, such as the embodiment of FIG. 8, a demonstration suit operates by having a user wear the suit on a certain part of the user's body, which then records demonstrations. These demonstrations are subsequently used to train an AI model. The suit is a wearable device aimed at robotic manipulation demonstration and data collection. In some examples, the suit may include one or more inertial measurement units that may be attached to the user's hand, arm, leg, or foot. These units are critical for tracking the pose and motion of the user's limbs. Additionally, the suit can incorporate one or more cameras aimed at the user's limbs or digits, optionally enhanced with visual markers to aid in motion tracking.

Force sensors, torque sensors, or force-torque sensors (see, for example, FIGS. 19-24) may be mounted on areas of the user's limbs or digits that contact external objects during the demonstration process. Mechanical sensors-such as, but not limited to, force sensors, torque sensors, force-torque sensors, strain gauges, accelerometers, pressure sensors, and tactile sensors-can also be employed to capture and measure various parameters of mechanical interaction.

In certain examples, a processor is specifically configured to capture synchronized data streams from the IMUs, cameras, and force sensors. It estimates poses of user limbs or digits based on the data from the IMUs and cameras and records demonstration data that includes video, force, and estimated limb pose streams.

A communication module can be included to transmit the recorded demonstration data to an external computer system, which then uses the transmitted demonstration data to train robotic manipulation skills. The system can also use an exoskeleton worn by the user (see, e.g., FIG. 8) to demonstrate additional strength or dexterity during the training process.

One embodiment includes a hand demonstration controller. See, FIGS. 6-7 and 19-22. The hand demonstration controller can comprise an elbow support system (see, FIG. 7) designed to relieve the weight from the user's hand during demonstrations. This system may come with an optional gimbal and support plates. Furthermore, a backpack support system shown in FIG. 8 can be included to relieve weight from the user's hand during demonstrations.

Referring to FIGS. 7 and 8, the elbow support system and the backpack support system discussed above are exemplary wearable aids that can be used in conjunction with the hand demonstration controller.

The present disclosure further addresses the potential of robots to undertake complex manipulation tasks to assist humans. The disclosure identifies the challenges in specifying intricate skills solely through programming and presents an alternative approach using human demonstrations to teach skills. Accordingly, systems and methods that enable natural skill demonstration for robotic learning using handheld devices are described. These devices are equipped with sensors to capture first-person perspective visual, motion, and force data streams during use. In some examples, a mounting plate, which may correspond to the standard robot ISO pattern on the hand demonstration device, can utilize integrated electrical triggers to actuate various end effector tools in discrete or continuous modes based on trigger displacements. See, e.g., FIGS. 19-30. These displacements may be encoded for additional training signals. As shown in FIGS. 9-17B, demonstration data, including video, global poses derived through visual-inertial odometry, gripper widths, and actuator positions, is recorded and transmitted to an external computer. This computer performs policy learning through imitation, with the learned policies being deployable directly onto a robot.

The present disclosure may also use components to enhance functionality, such as wrist supports, side mirrors, force sensors, torque sensors, force-torque sensors, feedback displays, and stabilization gimbals. An initialization wizard (see, e.g., FIGS. 9-17B) can aid in configuring tracking, grippers, and guides demonstration collection for a task. The collected data may be transferred to physics simulation for augmentation. As models are trained, operators receive guidance on providing additional demonstrations for challenging cases and when enough data is collected. The final skills can generalize across environments and may adapt online to correct suboptimal predictions.

The system for intuitive robotic skill demonstration and data collection can comprise an integrated camera positioned to capture first-person video demonstration footage, and a handheld device compatible with mountable end effector tools. Additionally, encoding components in the triggers or end effector jaws provide position/activation feedback data. One or more electrical triggering mechanisms, such as buttons, adjustable triggers, or a touchscreen, may be incorporated on the device. An actuation module interfaces with the triggers to activate end effector tools in either continuous or discrete modes.

The above system can perform all of the functions described in the present text, and can further include a mounting pattern (e.g., an ISO hole pattern) on the device compatible with existing end effectors, and hardware and software for tracking the device's location using an IMU and/or cameras on the device in real-time or post-processing.

A nearby computer can process data from the device to perform real-time tracking. Namely, the system further comprises a processing module configured to capture synchronized video, trigger, and encoder data streams, and record demonstration data comprising video and encoder or trigger data. This demonstration data can be used to train robotic manipulation policies via imitation learning.

Additional components such as force sensors, torque sensors, or force torque sensors mounted on the device measure forces and/or torques during demonstrations. See, for example FIGS. 19-24. The system may automatically transition to a force control mode upon forces exceeding a threshold, optionally using force controllers such as operational space or impedance controllers to achieve the forces and/or torques output by the model. The system may also include one or more mechanical sensors (e.g., force sensors, torque sensors, force-torque sensors, strain sensors, pressure gauges, accelerometers) attached to the grip trigger, an actuator configured to adjust trigger tension based on sensed grasp forces, providing intuitive grip strength modulation. See, for example FIGS. 19-24.

Further enhancements include one or more removable planar mirrors positioned in the camera's peripheral view to provide alternate environmental viewpoints during demonstration, with adjustable angles to the camera and the option to remove the mirrors. The tracking components may comprise inertial sensors and algorithms for visual simultaneous localization and mapping, tracking markers for tracking from external visual cameras or motion capture cameras, and logic selecting between visual SLAM vs. external motion tracking based on task, accuracy requirements, or user settings.

A processing module can estimate a global device pose using inertial and visual tracking, recording demonstration data comprising video, IMU, trigger, or data used to control the end effector based on its type.

A closed-loop learning subsystem may be configured to deploy a learned manipulation policy on a robot, detect suboptimal robot execution using sensors, and provide an interface for human supervisors to give additional demonstrations in response, further training the policy based on these additional demonstrations.

The system can further include a battery for wireless operation and allows human supervisors to take over via teleoperation to put the system back into a state suitable for autonomous operation or provide an immediate demonstration, further training the policy based on the additional demonstrations.

The system may also include a support structure that redistributes the weight of the device to the user's torso, alleviating strain on the wrist and can feature a mechanism that transfers the device's weight to either a fixed or movable mount within the environment, utilizing a pulley system for this purpose. An exoskeleton may be employed by the user to enhance the demonstration with additional strength or dexterity.

Voice commands, in some embodiments, may be integrated to control the arm, including functionalities such as starting or stopping recordings and saving or discarding previous recordings.

The device can be equipped with buttons or user interface elements, which can be on the device itself or on a secondary device, to initiate or halt recordings. Additionally, buttons are provided to denote in the training data when the arms need to synchronize at the current position or state, or to enter a more synchronized mode.

The device or a nearby user interface may allow setting force or torque goals for the duration of demonstrations. Feedback regarding the quality or quantity of the demonstration can be conveyed through visual indicators, audio signals, or haptic feedback either on the demonstration device or on a separate user interface. This feedback mechanism can also inform the user whether the demonstrations they are providing could feasibly be executed by a real robotic arm. In certain configurations, a screen, haptics, or at least one other user interface element may notify the user if movements exceed the capabilities of a real arm, based on absolute limits or adjustable safety settings.

A visualization of the arm in a simulator, possibly superimposed on a 3D scan, may allow the user to choose the preferred inverse kinematics (IK) solution. The device would maintain an open connection with a nearby tablet or computer, offering additional controls and live feedback on the demonstration data collection process. The system, encompassing both the hand demonstration controller and the demonstration arm, may utilize the gathered demonstration data to train transformer-based or diffusion models. Skills and training data can be shared or monetized through an API or a dedicated store, laying the groundwork for further training or the creation of new skills.

The device could be designed to train various skill models that can be summoned based on object or location recognition, with the skills being named and saved in a library for easy recall during inference times using a vision model. The device can serve as a foundational model, trained across numerous skills, and as part of a distributed demonstration network, allowing users with the device to demonstrate a queue of tasks. Users may be guided through the demonstration creation process via the user interface, which might include best practice guides, instructional videos, PDFs, or quizzes that provide real-time feedback. See, e.g., FIG. 12.

The system can select the appropriate foundational model based on either the comparison of predicted actions to the user's actual actions or visual similarity, among other criteria, to determine the required number of demonstrations for task completion (see, e.g., FIGS. 11-12). The system can allow behavior to be parameterized during inference, such as adjusting grip strength or force, enabling personalized settings without the need for retraining. The most relevant demonstrations from previous sessions can be selected based on task similarity to inform the training of new models, ensuring smoother demonstrations.

Configurable buttons, sliders, or user interface elements on the device or a separate display allow real-time control of the end effector during demonstrations, with the settings influencing the end effector's operation being saved as training data. A user interface can provide feedback to operators, particularly those inexperienced, on whether sufficient demonstrations have been provided to train a model that meets their needs. This assessment could be based on a predefined goal, the complexity of the task, or by running inference in the background during demonstrations to predict the sufficiency of collected data.

The system may facilitate connection to the demonstration device via an app or website for configuration purposes, such as WiFi settings, and supports uploading data to a remote repository for situations where direct robot operation is not feasible. External cameras can be added to provide additional angles in the training data. In some examples, a user interface displays guidance on the quality of the training data, potentially incorporating graphs to visualize aspects such as outliers in demonstrations, variations in force application, and pacing.

A wizard may assist users in setting up the device, guiding users through choices such as which input device to use, whether external trackers are needed, and the specifications of compatible grippers. Safety settings, such as force limits and soft axis boundaries, can be adjusted to ensure compliance with international safety standards like ISO 10218-1 and 10218-2. Users may have the option to scan their working environment with the device, facilitating the transfer of demonstrations to simulation for additional training. The system allows for the specification of maximum forces and torques when running inference with a model trained using these devices, ensuring accurate bimanual coordination and synchronization of actions across devices.

Post-processing adjustments can be made before training to maintain consistent grip force when objects are held, and additional demonstrations can be generated in simulation, with real-world demonstrations potentially being weighted more heavily. The entire process, from initial setup and scanning of the environment to the generation of additional demonstrations and training of the model, may be designed to be flexible and adaptable, catering to the variability expected in real-world applications.

Skills for various tasks, such as pick and place, sanding, welding, and more, can be programmed using this device, with a library of trained skills available for use. Joint constraints in demonstrations can be relaxed to accommodate a wider range of movements, and post-processing of video demonstrations can introduce additional training variability, helping the model learn to ignore irrelevant details.

Instructions can be obtained for generating additional demonstrations leverage scans and collected data to guide operators, potentially using AR/VR headsets for enhanced setup guidance. The system's structure supports deterministic setup of robot cells, minimizing variability between human and robot demonstrations, and incorporates external trackers to calibrate the device's tracking system, ensuring precise and effective training outcomes.

The present disclosure may further include an enhancement that entails displaying a live camera view on surfaces within a user interface. Additionally, the disclosure involves updating the visualized environment scan in real time as the robot navigates through the environment. This feature can allow for a more immersive and interactive experience by providing users with an up-to-date representation of the robot's surroundings, enhancing the precision and relevance of the demonstration or operation being conducted.

Moreover, the above-mentioned RCN that is trained using the methodologies outlined in the present text can leverage data collected either through a demonstration arm or a hand demonstration controller, embodying the intricacies and nuances of human demonstrations in a manner that is directly applicable to robotic learning. The integration of RCN into the system exemplifies the adoption of advanced machine learning techniques to refine the robot's understanding and execution of complex tasks, driven by the detailed and nuanced data captured during human demonstrations.

The present disclosure also emphasizes the utility of a live camera view projected onto surfaces within a user interface, as shown, for example in FIGS. 15-16. This real-time update of the visualized environment scan as the robot moves provides a dynamic and responsive visualization tool. The environment not only aids in monitoring the robot's immediate environment but also assists in planning and adjusting the robot's actions based on the live feedback received from the actual operating conditions.

The current disclosure may also include a scanning module located on a handheld device, such as the device of FIGS. 6-7 and 19-30, specifically designed for demonstrating robot actions. This portable scanning module facilitates the real-time capture and transmission of environmental data, thereby enabling the precise modeling of the environment in which the robot operates. The handheld nature of the device underscores the system's flexibility and ease of use, allowing users to directly interact with and influence the robot's learning process through live demonstrations. This approach significantly enhances the robot's ability to learn from human demonstrations, ensuring that the robot's actions are both accurate and adaptable to the complexities of real-world tasks.

The following list of numbered embodiments are further non-limiting example aspects of the present disclosure.

Embodiment 1: A method for enhancing robot programming interfaces, comprising: automatically generating descriptive narratives for each step in a robot's programming based on the step's symbolic representation and configuration.

Embodiment 2: The method of embodiment 1, further comprising: utilizing environmental scanning to recognize objects or locations in the robot's vicinity or to create collision-free paths between objects, and incorporating this information into the programming narratives.

Embodiment 3: The method of embodiment 2, wherein: The environmental scanning is facilitated by a neural network capable of object recognition and spatial awareness within a three dimensional (3D) environment.

Embodiment 4: The method of any one of embodiments 1-3, further comprising: Employing a language model to interpret natural language inputs for the creation, modification, and optimization of the robot's programming steps.

Embodiment 5: The method of embodiment 4, wherein: The language model facilitates interactive communication with the user to refine the programming steps based on image processing and feedback loops.

Embodiment 6: The method of embodiment 4 or 5, wherein: The language model utilizes a database of previous programming examples to assist in generating and optimizing robot routines based on user-provided descriptions and environmental context.

Embodiment 7: The method of any one of embodiments 1-3, further comprising: Identifying in the automatically generated narratives particular steps amenable to hand-off to pre-defined AI models, which complete parametric sub-tasks to accomplish the high-level step outlined in the narrative sequence.

Embodiment 8: A method for controlling a robot's tooltip using a mobile device, comprising: Synchronizing the movement of the tooltip with the movement of the mobile device.

Embodiment 9: The method of embodiment 8, wherein: The mobile device's orientation relative to the robot is determined using either manual input, a compass, or object detection from a camera.

Embodiment 10: The method of embodiment 8 or 9, further comprising: Providing a scaling mechanism to adjust the ratio of the mobile device's movement to the tooltip's movement, enabling both larger and smaller tooltip movements relative to the device's motion.

Embodiment 11: The method of any one of embodiments 8-10, wherein: The mobile device includes, but is not limited to, smartphones and tablets with capabilities for camera utilization and API access.

Embodiment 12: A method for authenticating users to control robot operating modes, comprising: Utilizing biometric authentication methods available on a user's mobile device.

Embodiment 13: The method of embodiment 12, further comprising: Employing facial recognition technology through a camera integrated with the robot or connected to the robot.

Embodiment 14: The method of embodiment 12 or 13, wherein: Successful authentication grants the user access to switch between different operating modes of the robot, in accordance with established safety standards.

Embodiment 15: The method of any one of embodiments 12-14, wherein: The biometric authentication methods include, but are not limited to, Face ID, fingerprint scanning, and other similar technologies.

Embodiment 16: The method of any one of embodiments 12-15, wherein: The authentication system replaces traditional PIN or passcode systems, enhancing the security and convenience of operating mode control.

Embodiment 17: A system for enhancing robot reliability, comprising: A mechanism for connecting robots to the internet to transmit operational data logs for centralized analysis.

Embodiment 18: The system of embodiment 17, wherein: The data analysis includes detecting anomalies in robot performance to trigger preventative maintenance actions.

Embodiment 19: The system of embodiment 17 or 18, further comprising: Monitoring key performance indicators including torque ripple, temperature variations in motor and gear units, and control box conditions.

Embodiment 20: The system of any one of embodiments 17-19, further comprising: Collecting Inertial Measurement Unit (IMU) data to detect shaking or instability in robot operations.

Embodiment 21: The system of any one of embodiments 17-20, further comprising: Analyzing waveforms related to the commutation of the robot's motor to assess its electrical performance and health.

Embodiment 22: The system of any one of embodiments 17-21, wherein: The comprehensive data analysis is used to identify usage patterns that may lead to premature failure, thereby enhancing the overall reliability and operational lifespan of the robots.

Embodiment 23: A bayonet mount system for securing a robot to a base, comprising: A mechanism allowing for alignment and securing of the robot to the base through a twisting motion.

Embodiment 24: The system of embodiment 23, further comprising: Integration of screws on the robot that align with corresponding holes on the base for additional securing after the bayonet mount is engaged.

Embodiment 25: The system of embodiment 24, wherein: The holes on the base are designed to constrict around the screws as the robot is twisted into position, locking the screws in place.

Embodiment 26: The system of any one of embodiments 23-25, wherein: The bayonet mount includes visual indicators to aid in the alignment of the robot with the base prior to securing.

Embodiment 27: The system of any one of embodiments 23-26, wherein: The bayonet mount system is specifically designed to facilitate the installation of heavy robots, reducing the physical strain on the installer.

Embodiment 28: A connection interface system for integrating third-party accessories with robot control boxes, comprising: Pre-crimped connectors for various third-party accessories.

Embodiment 29: The system of embodiment 28, further comprising: Clearly labeled screw terminals (or similar) on the robot control box, corresponding to different types of accessory connections.

Embodiment 30: The system of embodiment 28 or 29, further comprising: An integrated user interface on the robot that allows users to select the specific terminal block into which an accessory's screw terminal has been inserted.

Embodiment 31: The system of any one of embodiments 28-30, wherein: The connection interface includes a single connector that houses GPIO inputs, outputs, 24-volt IO, and ground connections.

Embodiment 32: The system of any one of embodiments 28-31, wherein: The system is designed to simplify the setup of accessories for users without electrical or robotics experience, functioning similarly to a USB plug-and-play interface.

Embodiment 33: A system comprising one or more small teleoperated leader robotic arms equipped with fixed or configurable physical or on-screen buttons for common real-time programming controls during kinesthetic guiding of one or more larger robotic follower arms.

Embodiment 34: The system of embodiment 33 wherein said leader arms have kinematic configurations scaled from and similar to said follower arms.

Embodiment 35: The system of embodiment 33 or 34 further comprising physical buttons positioned to be reachable by an operator's thumb while holding said leader arms, for real-time programming control during demonstrations.

Embodiment 36: The system of any one of embodiments 33-35 wherein said leader arms provide haptic feedback or dynamically adjustable gravity compensation force modes for lightweight synchronized operation with said follower arms.

Embodiment 37: The system of embodiment 36 wherein said adjustable gravity compensation modes vary forces exerted on said leader arms to provide feedback related to proximity to safety limits during demonstrations.

Embodiment 38: The system of any one of embodiments 33-37 further integrating voice command capabilities for hands-free control of system functions during demonstrations with said leader arms.

Embodiment 39: The system of any one of embodiments 33-38 further comprising artificial intelligence guidance capabilities to aid user skill building in demonstrations with said leader arms.

Embodiment 40: The system of any one of embodiments 33-39 further automatically re-synchronizing leader and follower arms upon moving out of sync during demonstrations via pressing a button on said leader arms or receiving indicators including audio, visual, or movement freezing cues that synchronization is reestablished.

Embodiment 41: The system of any one of embodiments 33-40 integrated with augmented reality or virtual reality headsets for intuitive demonstration visualization and control.

Embodiment 42: The system of any one of embodiments 33-41 wherein stereo camera feeds from follower robots provide a 3D view of the robot workspace.

Embodiment 43: The system of any one of embodiments 33-42 wherein said headsets track user eye movements which are interpreted by the system to allow hands-free selection of robot programming commands, camera video feeds, operational data, or other information displayed to the user through the headset.

Embodiment 44: The system of any one of embodiments 33-43 further enabling remote connectivity to experienced teleoperators for skill demonstration with said leader arms.

Embodiment 45: The system of any one of embodiments 33-44 further automatically detecting successful leader arm demonstrations for programming said follower arms, wherein integrated artificial intelligence models inspect recordings against predefined positional, temporal, force, status, and operations metrics to identify viable demonstrations meeting quality thresholds versus outliers to be filtered without manual review.

Embodiment 46: The system of any one of embodiments 33-45 wherein said leader arms further provide grip strength resistance that increases proportionally as the integrated gripper mechanism is closed with greater force during demonstrations, giving proportional force feedback to the user.

Embodiment 47: The system of any one of embodiments 33-46 wherein said leader arms are equipped with a dual-mode trigger mechanism allowing either a pulling operation or thumb-forefinger pinching operation to control gripper strength, wherein said pinching operation mimics motion of the gripper to intuitively tie demonstrator hand motions with the follower arm end effector actions.

Embodiment 48: A specialized hardware configuration for robots to facilitate AI learning or collision detection, comprising a distributed arrangement of cameras near end effectors, robotic joints, or appendages that allows more than one simultaneous view of the work area and area around the robot.

Embodiment 49: The system of embodiment 48 where multiple cameras are placed around at least one robotic joint or the gripper joint such that over 180-degree view is possible.

Embodiment 50: The system of embodiment 48 where multiple cameras are placed around at least one robotic joint or the gripper joint such that over 270-degree view is possible.

Embodiment 51: The system of any one of embodiments 48-50 where any two camera views can be used to extract a depth view of the surrounding scene.

Embodiment 52: The system of any one of embodiments 48-51 utilizing structure from motion techniques whereby depth data is extracted by cameras capturing multiple viewpoints from different arm positions.

Embodiment 53: The system of any one of embodiments 48-52 where a centralized computer or logic on the cameras is used to determine per-camera imaging properties during training and operation.

Embodiment 54: The system of any one of embodiments 48-53 wherein imaging property selection includes triggering autofocus, frame rate, resizing or crop events based on humans or objects detected in the scene.

Embodiment 55: The system of any one of embodiments 48-54 wherein said distributed cameras identify objects of interest to trigger autofocus, frame rate, resizing or crop adjustments on themselves and peers with preferable viewpoints of said objects.

Embodiment 56: The system of any one of embodiments 48-55 wherein said cameras feature built-in logic to dynamically regulate frame rates, resolution, and compression to prevent overloading system communications bandwidth.

Embodiment 57: The system of any one of embodiments 48-56 wherein visual signals from said cameras are processed to trigger immediate halting of arm movements when collisions are predicted.

Embodiment 58: The system of any one of embodiments 48-57 wherein occlusion onset or camera failure also trigger immediate halting of arm movements.

Embodiment 59: The system of any one of embodiments 48-58 further comprising modular staging tables tailored for multi-arm robot operation and movement into reconfigurable unified structures.

Embodiment 60: The system of any one of embodiments 48-59 further initiating automated multi-arm programming when proximal robots are detected on said unified staging tables.

Embodiment 61: A system for automatically generating robotic demonstration data in simulation comprising: a. A scanning module configured to automatically capture environmental data of real-world robotic environments for replication in simulation. b. A simulation generation module configured to produce data to train neural networks based on scanned data.

Embodiment 62: The system of embodiment 61 wherein the scanning module utilizes depth data.

Embodiment 63: The system of embodiment 61 or 62 wherein the scanning module is on the wrist of the robotic arm.

Embodiment 64: The system of any one of embodiments 61-63 wherein the scanning module incremental clears space to automatically scan environments without collisions.

Embodiment 65: The system of any one of embodiments 61-64 wherein the scanning module uses algorithms like Gaussian splatter to reconstruct the 3D scene.

Embodiment 66: The system of any one of embodiments 61-65 wherein the simulation generation module varies environmental textures, lighting conditions, object poses, camera mount points, and background object locations based on the scans or via generative neural networks.

Embodiment 67: The system of any one of embodiments 61-66 wherein the variation parameters define levels of simulated environment changes like pose or lighting, textures, noise, errors, failures, or edge cases to be introduced into the demonstration data.

Embodiment 68: The system of any one of embodiments 61-67 further comprising neural networks configured to recognize objects in the scans and automatically replace those with models that simulate their physics.

Embodiment 69: The system of any one of embodiments 61-68 where the neural networks trained with the simulated data are designed to output object classifications, segmentation, or pose detection when run on real-world cameras.

Embodiment 70: A system for generating training data for robots in simulation wherein: a generative model is pretrained on human demonstration prior to iterative data generation; wherein demonstration complexity and variability coverage increases over multiple data generations by variation of object poses, lighting, textures, or introducing edge cases via generative networks; and wherein reward models identify data quality and guide exploration during training data collection and generation.

Embodiment 71: A system for generating training data for robots in simulation wherein: variability is expanded along user-specified axes by perturbing camera angles, object locations, or other factors demonstration complexity and variability coverage increases over multiple data generations by variation of object poses, lighting, textures, or introducing edge cases via generative networks; wherein reward model neural networks identify data quality and guide exploration during data collection and generation.

Embodiment 72: A system for generating training data for robots in simulation wherein: a generative model is pretrained on human demonstrations prior to iterative data generation. variability is expanded along user-specified axes by perturbing camera angles, object locations, or other factors. a reward model identifies trajectory qualities and guide exploration during data collection and generation, demonstration complexity and variability coverage increases over multiple data generations by variation of object poses, lighting, textures, and introducing edge cases via generative networks, further comprising injection of generally desired behaviors into simulation demonstrations including pausing when humans are detected nearby, further comprising dynamic collision detection based on expected forces so that contact during operation does not prematurely terminate execution.

Embodiment 73: The system of embodiment 71 and embodiment 61, 62, or 63.

Embodiment 74: The system of embodiment 72 and embodiment 61, 62, or 63.

Embodiment 75: The system of any one of embodiments 61-74 wherein demonstration complexity is gradually increased using generative networks to induce failures, expand variability, and generate additional resilient demonstration data.

Embodiment 76: The system of any one of embodiments 61-75 further comprising reward model neural networks trained to identify trajectory qualities and constrain exploration to efficient, collision-free paths during data collection.

Embodiment 77: The system of any one of embodiments 61-76 wherein demonstration data includes predefined termination conditions and secondary routines for handling simulated failure modes.

Embodiment 78: The system of any one of embodiments 61-77 wherein neural networks classify demonstration start, stop, success criteria, select skill routines, and provide user feedback.

Embodiment 79: The system of any one of embodiments 61-78 wherein teacher-student models transfer demonstration strategies from noisy inputs to refined outputs for sample-efficient learning.

Embodiment 80: The system of any one of embodiments 61-79 wherein the simulation constrains exploration spaces and robot axes for safety during training and with hard stop limits during runtime.

Embodiment 81: The system of any one of embodiments 61-80 wherein additional real-world demonstrations are uploaded to simulation after deployment for retraining models on new scenarios.

Embodiment 82: A system as in any one of embodiments 61-81 wherein the simulation generation module constructs simulated environments using 3D scans, lighting and texture data captured by the scanning module, and calibrated camera models.

Embodiment 83: A system as in embodiment 77 wherein the simulation generation module renders the simulated environments with photorealistic lighting and textures.

Embodiment 84: A system as in any one of embodiments 61-83 wherein the data collection module uses adversarial techniques or noise injection to generate failed demonstrations for additional simulation and training.

Embodiment 85: A system as in any one of embodiments 61-84 wherein reward model neural networks identify trajectory qualities and guide exploration during data collection and generation.

Embodiment 86: A system as in any one of embodiments 61-85 wherein demonstration complexity increases over generations by variation of object poses, lighting, textures, and introducing edge cases via generative networks.

Embodiment 87: A system as in any one of embodiments 61-86 wherein the training module pretrains neural network models on human demonstrations prior to iterative data generation.

Embodiment 88: A system as in any one of embodiments 61-87 wherein the neural network models are based on multimodal generative language models.

Embodiment 89: A system as in any one of embodiments 61-88 wherein policies trained on generated simulated demonstrations can be deployed on physical robotic systems to handle real-world variability.

Embodiment 90: A system as in any one of embodiments 61-89 wherein generative neural networks upscale 3D scans to higher resolution for realistic simulation.

Embodiment 91: A system as in any one of embodiments 61-90 wherein background environments are selectively blurred in simulation using depth data to focus learning on foreground objects.

Embodiment 92: A system as in any one of embodiments 61-91 wherein the level of background blurring is a user-controlled parameter.

Embodiment 93: A system as in any one of embodiments 61-92 wherein background environments are varied across simulation camera angles to improve resilience to distractors.

Embodiment 94: A system as in any one of embodiments 61-93 further comprising a mechanism to perturb camera poses between demonstrations.

Embodiment 95: A system as in embodiment 89 wherein camera perturbation is by physical contact or simulated camera movement.

Embodiment 96: A system as in embodiment 89 wherein small camera movements during training improve resilience of learned policies to real-world camera instability.

Embodiment 97: A system as in any one of embodiments 61-96 wherein the neural network models are based on conditional diffusion generative models and multimodal generative language models.

Embodiment 98: A system as in any one of embodiments 61-97 wherein demonstration complexity and variability coverage increases over multiple data generations by variation of object poses, lighting, textures, and introducing edge cases via generative networks.

Embodiment 99: A system as in any one of embodiments 61-98 wherein reinforcement learning from human feedback rates demonstration performance in simulation.

Embodiment 100: A system as in any one of embodiments 61-99 wherein variability is expanded along user-specified axes by perturbing camera angles, object locations, or other factors.

Embodiment 101: A system as in any one of embodiments 61-100 wherein complexity increases over generations by model attempts under variable conditions, generating additional demonstrations from diffusion models when unsuccessful.

Embodiment 102: A system as in any one of embodiments 61-101 further comprising neural network reward models identifying trajectory efficiency, collisions, and goal achievement to guide data generation.

Embodiment 103: A system as in any one of embodiments 61-102 further comprising teacher-student models to distill strategies from noisy demonstrations into refined policies.

Embodiment 104: A system as in any one of embodiments 61-103 wherein foundational models encode generally desired behaviors prior to simulation-based training.

Embodiment 105: A system as in any one of embodiments 61-104 wherein additional real-world demonstrations are used to retrain policies and account for incremental variability.

Embodiment 106: The controller of any one of embodiments 61-105 further comprising analysis of demonstration time series to identify variability and automatically scale the number of required training demonstrations.

Embodiment 107: The controller of any one of embodiments 61-106 further comprising injection of generally desired behaviors into simulation demonstrations including pausing when humans are detected nearby.

Embodiment 108: The controller of any one of embodiments 61-107 further comprising dynamic collision detection based on expected forces so that contact during operation does not prematurely terminate execution.

Embodiment 109: A RCN wherein demonstrated skill routines are saved as neural network model steps for reuse in programs alongside normal robot program steps.

Embodiment 110: A RCN adapted to organize demonstrations into reusable foundation skill models based on user-provided task labels including object types, skill types, descriptive embeddings, or summarization descriptions.

Embodiment 111: A RCN wherein prebuilt foundation models for human handoff behaviors or behaviors to avoid collisions with objects or humans.

Embodiment 112: A RCN wherein camera resolution and model size adapt based on properties and complexity of a manipulation task.

Embodiment 113: A RCN wherein further comprising interfaces for integration of sensors including depth, thermal, spectral, inertia, torque, kinematic, or fieldbus data.

Embodiment 114: A RCN comprising automatic outlier identification and guided data expansion for improving model resilience.

Embodiment 115: A RCN wherein the model uses automatic outlier identification and guided data expansion for improving model resilience.

Embodiment 116: A RCN wherein precondition constraints on skill execution context.

Embodiment 117: A RCN wherein preconditions include robotic arm position, gripper state, peripheral states, prior step outcomes, or scene properties.

Embodiment 118: A RCN adapted for control of secondary robotic axes including vertical lifts or 7th axes.

Embodiment 119: A RCN embodied in a centralized server with accelerator hardware connected to multiple robots.

Embodiment 120: The RCN of embodiment 117 wherein centralized embodiment enables load balancing of inference across shared acceleration hardware.

Embodiment 121: The controller of embodiment 117 wherein centralized embodiment enables load balancing of inference across shared acceleration hardware.

Embodiment 122: A RCN comprising interfaces enabling user sharing and execution of saved skill models.

Embodiment 123: A RCN with interfaces enabling user review, selection and retraining of existing foundation models.

Embodiment 124: A RCN further comprising automatic selection of foundation models for new tasks based on demonstration embedding similarities.

Embodiment 125: A RCN adapted to utilize inputs including sound, magnetic, depth, thermal, inertial, torque, kinematic, stereo depth, or non-visual (like UV) camera data to enhance skill model accuracy.

Embodiment 126: The RCN of embodiment 124 further comprising on-device neural networks for processing sensory data into model inputs.

Embodiment 127: A RCN providing neural network controllers access to non-visual task context including programming state, physics computations, or peripheral robot data to aid skill execution.

Embodiment 128: A RCN adapted to allow remote operator takeover on low model confidence predictions during inference.

Embodiment 129: A RCN offering varying tiers of manipulation speed and precision based on user selected deployment or payment tiers preferences.

Embodiment 130: A RCN providing neural network skill models access to request-based robot functions enabling real time retrieval of context values calculated on-demand to enhance manipulation accuracy.

Embodiment 131: A RCN wherein the neural network controller implements a bag of experts model architecture comprising a set of specialized expert networks and a gating network.

Embodiment 132: The RCN of embodiment 131 wherein the gating network determines which expert network to consult based on the manipulation context.

Embodiment 133: The system of embodiment 109 comprising the features of embodiment 110 and/or embodiment 111.

Embodiment 134: The system of embodiment 109 comprising the features of embodiment 111 and/or embodiment 112.

Embodiment 135: The system of embodiment 109 comprising the features of embodiment 112 and/or embodiment 113.

Embodiment 136: The system of embodiment 109 comprising the features of embodiment 113 and/or embodiment 114.

Embodiment 137: The system of embodiment 109 comprising the features of embodiment 114 and/or embodiment 115.

Embodiment 138: The system of embodiment 109 comprising the features of embodiment 115 and/or embodiment 116.

Embodiment 139: The system of embodiment 109 comprising the features of embodiment 116 and/or embodiment 117.

Embodiment 140: The system of embodiment 109 comprising the features of embodiment 117 and/or embodiment 118.

Embodiment 141: The system of embodiment 109 comprising the features of embodiment 118 and/or embodiment 119.

Embodiment 142: The system of embodiment 109 comprising the features of embodiment 119 and/or embodiment 120.

Embodiment 143: The system of embodiment 109 comprising the features of embodiment 120 and/or embodiment 121.

Embodiment 144: The system of embodiment 109 comprising the features of embodiment 121 and/or embodiment 122.

Embodiment 145: The system of embodiment 109 comprising the features of embodiment 122 and/or embodiment 123.

Embodiment 146: The system of embodiment 109 comprising the features of embodiment 123 and/or embodiment 124.

Embodiment 147: The system of embodiment 109 comprising the features of embodiment 124 and/or embodiment 125.

Embodiment 148: The system of embodiment 109 comprising the features of embodiment 125 and/or embodiment 126.

Embodiment 149: The system of embodiment 109 comprising the features of embodiment 126 and/or embodiment 127.

Embodiment 150: The system of embodiment 109 comprising the features of embodiment 127 and/or embodiment 128.

Embodiment 151: The system of embodiment 109 comprising the features of embodiment 128 and/or embodiment 129.

Embodiment 152: The system of embodiment 109 comprising the features of embodiment 129 and/or embodiment 130.

Embodiment 153: The system of embodiment 109 comprising the features of embodiment 130 and/or embodiment 131.

Embodiment 154: The system of embodiment 109 comprising the features of embodiment 131 and/or embodiment 132.

Embodiment 155: The system of embodiment 109 comprising the features of embodiment 132 and/or embodiment 133.

Embodiment 156: The system of embodiment 110 comprising the features of embodiment 109 and/or embodiment 111.

Embodiment 157: The system of embodiment 110 comprising the features of embodiment 111 and/or embodiment 112.

Embodiment 158: The system of embodiment 110 comprising the features of embodiment 112 and/or embodiment 113.

Embodiment 159: The system of embodiment 110 comprising the features of embodiment 113 and/or embodiment 114.

Embodiment 160: The system of embodiment 110 comprising the features of embodiment 114 and/or embodiment 115.

Embodiment 161: The system of embodiment 110 comprising the features of embodiment 115 and/or embodiment 116.

Embodiment 162: The system of embodiment 110 comprising the features of embodiment 116 and/or embodiment 117.

Embodiment 163: The system of embodiment 110 comprising the features of embodiment 117 and/or embodiment 118.

Embodiment 164: The system of embodiment 110 comprising the features of embodiment 118 and/or embodiment 119.

Embodiment 165: The system of embodiment 110 comprising the features of embodiment 119 and/or embodiment 120.

Embodiment 166: The system of embodiment 110 comprising the features of embodiment 120 and/or embodiment 121.

Embodiment 167: The system of embodiment 110 comprising the features of embodiment 121 and/or embodiment 122.

Embodiment 168: The system of embodiment 110 comprising the features of embodiment 122 and/or embodiment 123.

Embodiment 169: The system of embodiment 110 comprising the features of embodiment 123 and/or embodiment 124.

Embodiment 170: The method or system of any of the preceding embodiments further comprising: showing a live camera view projected on surfaces in a user interface and/or updating the visualized environment scan in real-time as the robot moves around.

Embodiment 171: The system or method of any of the preceding embodiments further comprising showing a live camera view projected on surfaces in a user interface and updated the visualized environment scan in real-time as the robot moves around.

Embodiment 172: A RCN trained with the method of any of the preceding embodiments, where the RCN is trained using a demonstration arm or hand demonstration controller.

Embodiment 173: The system or method of any of the preceding embodiments, where the user interface shows a live camera view projected on surfaces in a user interface and updates the visualized environment scan in real-time as the robot moves around.

Embodiment 174: The system or method of any of embodiments 61 to 173, where the scanning module is on a handheld device for demonstrating robot actions.

Embodiment 175: A system for intuitive robotic skill demonstration and data collection, comprising: an integrated camera positioned to capture first-person video demonstration footage; a handheld device compatible with mountable end effector tools.

Embodiment 176: A system for intuitive robotic skill demonstration and data collection, comprising: an integrated camera positioned to capture first-person video demonstration footage; encoding components in the triggers or end effector jaws providing position/activation feedback data.

Embodiment 177: A system for intuitive robotic skill demonstration and data collection, comprising: an integrated camera positioned to capture first-person video demonstration footage; one or more electrical triggering mechanisms on the device such as buttons, adjustable triggers, or a touchscreen; an actuation module interfacing with the triggers to activate end effector tools continuously or in discrete modes.

Embodiment 178: A system according to any one of embodiments 175 to 177, further comprising every combination of the systems described therein.

Embodiment 179: A system according to any one of embodiments 175 to 178, further comprising an ISO hole pattern on the device compatible with existing end effectors.

Embodiment 180: A system according to any one of embodiments 175 to 179, further comprising hardware and software for tracking the location of the device using an IMU and/or cameras on the device in real-time or in post-processing, wherein a nearby computer processes data from the device to perform the real-time tracking.

Embodiment 181: A system according to any one of embodiments 175 to 180, further comprising a processing module configured to capture synchronized video, trigger, and encoder data streams, record demonstration data comprising video, and encoder or trigger data, wherein the demonstration data trains robotic manipulation policies via imitation learning.

Embodiment 182: A system according to any one of embodiments 175 to 181, further comprising a force or torque sensor mounted on the device to measure forces and/or torques during demonstrations.

Embodiment 183: A system according to any one of embodiments 175 to 182, wherein at inference time, the system: automatically transitions to a force control mode upon forces exceeding a threshold; and optionally uses force controllers such as operational space or impedance controllers to achieve the forces or torques output by the model.

Embodiment 184: A system according to any one of embodiments 175 to 183, further comprising: one or more removable planar mirrors positioned in the camera's peripheral view, wherein the mirrors provide alternate environmental viewpoints during demonstration, are configured at adjustable angles to the camera, and are optionally removable.

Embodiment 185: A system according to any one of embodiments 175 to 184, wherein the tracking components comprise: inertial sensors and algorithms for visual simultaneous localization and mapping (SLAM); tracking markers for tracking from external visual cameras or motion capture cameras; and logic selecting between visual SLAM vs. external motion tracking, for example, based on task, accuracy requirements, or user settings.

Embodiment 186: A system according to any one of embodiments 175 to 185, further comprising: one or more force sensors attached on the grip trigger; and an actuator configured to adjust trigger tension based on sensed grasp forces, wherein force feedback provides intuitive grip strength modulation.

Embodiment 187: A system according to any one of embodiments 175 to 186, further comprising a processing module configured to estimate global device pose using inertial and visual tracking, record demonstration data comprising video, IMU, trigger, or data used to control the end effector based on its type.

Embodiment 188: A system according to any one of embodiments 175 to 187, further comprising a closed-loop learning subsystem configured to: deploy a learned manipulation policy on a robot; detect suboptimal robot execution using sensors; provide an interface for human supervisors to give additional demonstrations in response; and further train the policy based on the additional demonstrations.

Embodiment 189: A system according to any one of embodiments 175 to 188, further having a battery for wireless operation.

Embodiment 190: A system according to any one of embodiments 175 to 189, further comprising a closed-loop learning subsystem configured to: deploy a learned manipulation policy on a robot; detect suboptimal robot execution using sensors; and provide an interface for human supervisors to take over via teleoperation to put the system back into a state suitable for autonomous operation.

Embodiment 191: A system according to any one of embodiments 175 to 190, further comprising a closed-loop learning subsystem configured to: deploy a learned manipulation policy on a robot; detect suboptimal robot execution using sensors; provide an interface for human supervisors to take over via teleoperation to provide an immediate demonstration; and further train the policy based on the additional demonstrations.

Embodiment 192: A system according to any one of embodiments 175 to 191, with any combination of these modifications: buttons or user interface elements (whether displayed on the device or displayed on a second device) to save or discard the previous attempt; where the angle between the handle and the rest of the device is adjustable; and a strap that attaches to the user's wrist or forearm to relieve pressure on the hand over periods of long operation, with or without a wrist pivot so the user can freely move their wrist, that may have straps that loop around the lower arm to help hold the weight.

Embodiment 193: A robotic training system comprising one or more leader robotic devices configured for human manipulation; one or more follower robotic devices configured to replicate movements of the leader robotic devices; at least one user control interface physically mounted on the leader robotic devices configured to control demonstration recording operations and synchronization between leader and follower robotic devices.

Embodiment 194: The system of embodiment 193, further comprising a motion modification module configured to perform at least one of: modify the perceived weight of the leader robotic devices; provide haptic feedback based on states of the follower robotic devices; and adjust movement scaling between leader and follower robotic devices.

Embodiment 195: A handheld device for robotic skill demonstration comprising a body portion configured to be manipulated by a user; an ISO-pattern interface configured to mount interchangeable electromechanical end effector tools; and one or more sensors configured to capture demonstration data.

Embodiment 196: A handheld device for robotic skill demonstration comprising a body portion configured to be manipulated by a user; one or more methods to measure forces or torques; and one or more sensors configured to capture demonstration data.

Embodiment 197: A handheld device for robotic skill demonstration comprising a body portion configured to be manipulated by a user; one or more continuous-range control inputs configured to control end effector activation; and one or more sensors configured to capture demonstration data.

Embodiment 198: A handheld device for robotic skill demonstration comprising a body portion configured to be manipulated by a user; one or more control inputs mounted on the device configured to control demonstration recording operations; and one or more sensors configured to capture demonstration data.

Embodiment 199: A handheld device for robotic skill demonstration comprising a body portion configured to be manipulated by a user; battery power for wireless operation; and one or more sensors configured to capture demonstration data.

Embodiment 200: A handheld device for robotic skill demonstration comprising a body portion configured to be manipulated by a user; a support system configured to offset device weight from the user's hand; and one or more sensors configured to capture demonstration data.

Embodiment 201: The system of any one of embodiments 193-200, further comprising a sensor system providing multiple viewpoints of a workspace, wherein at least one sensor is positioned independently from and provides a view of the follower robotic devices.

Embodiment 202: The system of any one of embodiments 193-201, further comprising a feedback system configured to evaluate at least one of kinematic feasibility, dynamic feasibility, and workspace feasibility; and provide real-time feedback to the user through at least one of visual indicators, audio signals, and haptic feedback.

Embodiment 203: The system of any one of embodiments 193-202, wherein the system includes a parameter extraction module configured to process demonstrated trajectories to extract high-level task parameters for procedural code generation or output high-level task parameters directly from a trained model, wherein the parameters configure procedural task execution code.

Embodiment 204: A robotic control system comprising a learned policy module trained from demonstration data; and a control module configured to operate the robot using position control for trajectory following, operate the robot using force control for interaction tasks, and automatically transition between position control and force control during task execution based on sensed interaction forces between the robot and environment and outputs from the learned policy module indicating desired control modes.

Embodiment 205: A method for robot programming comprising receiving robot program steps; automatically generating natural language descriptions of robot actions for each step based on one of robot configuration data, environmental data, and robot action parameters; and creating a human-readable narrative sequence of the robot program.

Embodiment 206: The method of embodiment 205, wherein at least one robot program step comprises an AI skill, wherein an AI skill refers to a robot program step that utilizes a trained machine learning model to determine robot actions based on sensor inputs and/or environmental conditions, where the model has been trained on demonstration data, synthetic data, or through reinforcement learning.

Embodiment 207: A robotic data collection system comprising an instruction interface configured to provide feedback on data quality and a data management platform enabling annotation of collected data, version control of trained models, and deployment to physical robots.

Embodiment 208: A demonstration data processing system comprising an interface enabling temporal segmentation of demonstration videos; a labeling module configured to associate text labels with video segments and track labeled actions across demonstrations; and a training module configured to use labeled segments for targeted skill learning.

Embodiment 209: A robotic control system comprising a learning module trained on human demonstration data; a plurality of sensors configured to capture at least one of sound data, magnetic field data, depth data, thermal data, inertial data, torque data, kinematic data, stereo depth data, and non-visible spectrum camera data; wherein the learning module is configured to receive real-time sensor data from the plurality of sensors and process the sensor data to enhance accuracy of learned skills during task execution.

Embodiment 210: The system of embodiment 209, wherein the learning module comprises a neural network trained to integrate multiple sensor modalities and a skill execution component that uses the integrated sensor data to modify robot actions in real-time.

Embodiment 211: A robotic learning system comprising a policy module trained on demonstration data; a monitoring module configured to detect suboptimal task execution using sensor data and trigger collection of additional demonstration data; an interface enabling human supervisors to provide corrective demonstrations; and a learning module configured to incorporate the corrective demonstrations into the policy module through additional training.

Embodiment 212: The system of embodiment 211, wherein the interface enables real-time takeover of robot control by the human supervisor and collection of corrective demonstration data starting from the detected suboptimal execution state.

Embodiment 213: A system for sharing robotic skills comprising a database of trained skill models; an interface enabling users to upload trained skill models, download skill models, and monetize shared skill models; wherein the skill models can be used as foundation models for additional training or creating new skills.

Embodiment 214: The system of embodiment 213 further comprising a verification module to validate uploaded skill models; a rating system for skill model quality; and a licensing framework for controlling skill model usage.

Embodiment 215: A system for managing robotic skills comprising a library of skill models trained through demonstration; a vision module configured to recognize objects and environments and select appropriate skill models based on recognized elements; and an interface enabling naming and categorizing demonstrated skills, manual selection of skills during programming, and API-based skill activation.

Embodiment 216: The system of embodiment 215 wherein the vision module employs object detection models, scene understanding models, and skill selection models trained to match visual scenes to appropriate skills.

Embodiment 217: A robotic task verification system comprising a neural network configured to analyze sensor data after task execution and detect task completion status through at least one of object detection, instance segmentation, and state estimation; and a task management module configured to record task success/failure and trigger corrective actions upon failure detection.

Embodiment 218: A system for generating training data for robots in simulation wherein a generative model is pretrained on human demonstration prior to iterative data generation; wherein demonstration complexity and variability coverage increases over multiple data generations by variation of object poses, lighting, textures, or introducing edge cases via generative networks; and wherein reward models identify data quality and guide exploration during training data collection and generation.

Embodiment 219: A system for automatically generating robotic demonstration data in simulation comprising a scanning module configured to automatically capture environmental data of real-world robotic environments for replication in simulation; and a simulation generation module configured to produce data to train neural networks based on scanned data.

Embodiment 220: A system for synthetic robot training data generation comprising a scanning module configured to capture 3D environmental data from real robot workspaces and process captured data for use in simulation environments; a simulation module configured to generate synthetic training scenarios based on scanned environments and vary environmental parameters including object poses, lighting conditions, surface textures, and background elements; and a data quality module configured to evaluate generated scenarios against quality metrics and guide further data generation based on coverage needs.

Embodiment 221: The method of embodiment 220 wherein the reward models evaluate task success likelihood, motion naturalness, coverage of target distribution, and physical feasibility.

Embodiment 222: A system for robot skill learning comprising a demonstration interface configured to receive one or more demonstrations of a target skill and natural language or text prompts describing desired robot behavior; a model selection module configured to process the text prompts to determine task requirements and select appropriate foundation models for the task by comparing predicted actions from different foundation models against demonstration actions, evaluating visual or task similarity metrics, and using user-applied labels or categories; and a learning module configured to adapt the selected foundation model using the demonstrations, incorporate the text prompts to guide task execution, and enable real-time parameter adjustment through additional prompts.

Embodiment 223: A bayonet mount system for securing a robot to a base, the system comprising a bayonet interface configured to guide the robot into a correct orientation through mechanical keying, and to support the robot's weight upon partial rotation from an insertion position to a locked position.

Embodiment 224: The method or system of any of the preceding embodiments further comprising showing a live camera view projected on surfaces in a user interface and/or updating the visualized environment scan in real-time as the robot moves around.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein. Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

All prior patents, publications, and test methods referenced herein are incorporated by reference in their entireties.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

Any feature or element that is positively identified in this description may also be specifically excluded as a feature or element of an embodiment of the present disclosure as defined in the claims.

As used herein, the term “consisting essentially of” limits the scope of a specific claim to the specified materials or steps and those that do not materially affect the basic and novel characteristic or characteristics of the specific claim.

The disclosure described herein may be practiced in the absence of any element or elements, limitation or limitations, which is not specifically disclosed herein. Thus, for example, in each instance herein, any of the terms “comprising,” “consisting essentially of and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A robotic training system comprising:
one or more leader robotic devices configured for human manipulation; and
one or more follower robotic devices configured to replicate at least one movement of the one or more leader robotic devices; and
one or more force sensors, torque sensors, or force-torque sensors on at least one of: the one or more leader robotic devices, one or more of the one or more follower robotic devices, or any combination thereof;
where the robotic training system is configured to:
process force data, torque data, or force-torque data measured by the one or more force sensors, torque sensors, or force-torque sensors among the one or more leader robotic devices and the one or more follower robotic devices, where the force data, torque data, or force-torque data corresponds to one or more physical actions performed by the robotic training system; and
record the force data, torque data, or force-torque data as demonstration data, where the demonstration data is adapted for training of at least one artificial intelligence (AI) model, where the AI model is designed to train at least one robot to perform the one or more physical actions performed by the robotic training system.

2. The robotic training system of claim 1, where the one or more physical actions comprise at least one of: lifting, twisting, pouring, translating, carrying, moving, tipping, any other physical action, or any combination thereof.

3. The robotic training system of claim 1, further comprising at least one user control interface physically mounted on the one or more leader robotic devices, the at least one user control interface configured to control at least one of: one or more demonstration recording operations, synchronization between the one or more leader and follower robotic devices, or any combination thereof.

4. The robotic training system of claim 1, further comprising a sensor system comprising at least one additional sensor, wherein the sensor system is configured to provide multiple viewpoints of a workspace, and wherein at least one additional sensor is positioned independently from and provides a view of the one or more follower robotic devices.

5. The robotic training system of claim 4, where the at least one additional sensor is configured to capture least one of: sound data, magnetic field data, depth data, thermal data, inertial data, kinematic data, stereo depth data, non-visible spectrum camera data, or any combination thereof.

6. The robotic training system of claim 1, further comprising a motion modification module configured to perform at least one of: modifying a perceived weight of the one or more leader robotic devices, providing haptic feedback based on states of the one or more follower robotic devices, adjusting movement scaling between leader and follower robotic devices, or any combination thereof.

7. A robotic training system comprising:
one or more leader robotic devices configured for human manipulation; and one or more follower robotic devices configured to replicate at least one movement of the one or more leader robotic devices;
one or more interchangeable electromechanical end effector tools mounted on at least one of: the one or more leader robotic devices, the one or more of follower robotic devices, or any combination thereof;
where the robotic training system is configured to:
process information corresponding to one or more physical actions performed using the one or more interchangeable electromechanical end effector tools among the one or more leader robotic devices and the one or more follower robotic devices; and
record the information corresponding to the one or more physical actions performed using the one or more interchangeable electromechanical end effector tools as demonstration data, where the demonstration data is adapted for training of at least one artificial intelligence (AI) model, where the AI model is designed to train at least one robot to perform the one or more physical actions performed by the robotic training system.

8. A handheld device for robotic skill demonstration comprising:
a body portion configured to be manipulated by a user; and
one or more force sensors, torque sensors, or force-torque sensors configured to measure force data, torque data, or force-torque data;
where the handheld device is configured to record the force data, the torque data, or the force-torque data as demonstration data, where the force data, torque data, or force-torque data corresponds to one or more physical actions performed by the user with the handheld device,
and where the demonstration data is adapted for training of at least one artificial intelligence (AI) model, where the AI model is designed to train, using the force data, torque data, or force-torque data, at least one robot to perform the one or more physical actions demonstrated by the user.

9. The handheld device of claim 8, further comprising one or more interchangeable electromechanical end effector tools.

10. The handheld device of claim 9, wherein the force data, the torque data, or the force-torque data measured by the one or more force sensors, torque sensors, or force-torque sensors comprise at least one of: force associated with gripping of the one or more interchangeable electromechanical end effector tools, torque associated with weighted rotation of the one or more interchangeable electromechanical end effector tools, or any combination thereof.

11. The handheld device of claim 8, further comprising one or more cameras, where the one or more cameras are configured to capture additional force data, torque data, or force-torque data by capturing physical evidence of deformation.

12. The handheld device of claim 8, further comprising one or more cameras, where the one or more cameras comprise at least one of: a time-of-flight “ToF” camera; a stereo depth camera; or any combination thereof.

13. The handheld device of claim 8, further comprising one or more cameras present on a mobile device, where the handheld device is configured to house the mobile device, the one or more cameras allowing a vantage point of the mobile device to be synchronized with the vantage point of visual data captured by the one or more cameras.

14. A handheld device for robotic skill demonstration comprising:
a body portion configured to be manipulated by a user; and
a mounting interface configured to mount one or more interchangeable electromechanical end effector tools configured to be manipulated by the user;
where the handheld device is configured to record one or more physical actions performed by the user with the handheld device using the one or more interchangeable electromechanical end effector tools as demonstration data, and
where the demonstration data is adapted for training of at least one artificial intelligence (AI) model, where the AI model is designed to train at least one robot to perform the one or more physical actions demonstrated by the user using the one or more interchangeable electromechanical end effector tools.

15. The handheld device of claim 14, wherein the mounting interface is an ISO pattern interface.

16. The handheld device of claim 14, wherein the body portion comprises an electronic trigger, wherein the electronic trigger is configured to manipulate the one or more interchangeable end effector tools.

17. The handheld device of claim 14, wherein interchangeable electromechanical end effector tools comprise one or more interchangeable grippers, one or more customizable fingers, or any combination thereof.

18. The handheld device of claim 14, further comprising one or more continuous-range control inputs configured to control end effector activation.

19. The handheld device of claim 14, further comprising one or more cameras present on a mobile device, where the handheld device is configured to house the mobile device, the one or more cameras allowing a vantage point of the mobile device to be synchronized with the vantage point of visual data captured by the one or more cameras.

20. A robotic control system comprising:
a learned policy module trained from demonstration data, where the demonstration data comprises:
force data, torque data, or force-torque data corresponding to sensed interaction forces between a robot and a corresponding environment, and
visual data corresponding to a vantage point of a user while performing one or more physical actions; and
a control module configured to:
operate one or more robots using position control for trajectory following;
operate one or more robots using force control for interaction tasks; and
automatically transition between position control and force control during task execution based on sensed interaction forces between the one or more robots and an environment, automatically transition between outputs from the learned policy module indicating desired control modes, or any combination thereof.

21. The robotic control system of claim 20, wherein the transition between position control and force control is on a per-axis basis, whereby a given axis of the robot is independently controllable in at least one of position control mode or force control mode, or any combination thereof, while one or more other axes of the robot are independently controllable in at least one of position control mode or force control mode, or any combination thereof.

22. The robotic control system of claim 20, further comprising a task verification system comprising a neural network configured to analyze sensor data after task execution and detect task completion status through at least one of object detection, instance segmentation, and state estimation; and a task management module configured to record task success or failure and trigger corrective actions upon failure detection.

23. The robotic control system of claim 20, wherein the learned policy module comprises a generative model pretrained on the demonstration data prior to iterative data generation, wherein demonstration complexity and variability coverage increases over multiple data generations by variation of object type, variation of object shape, variation of object size, variation of object poses, lighting, texture, color, background elements, introducing edge cases via generative networks, or any combination thereof, and wherein reward models identify data quality and guide exploration during training data collection and generation.

24. The robotic control system of claim 20, further comprising:
a training data generation module comprising a scanning module configured to capture three-dimensional environmental data from real robot workspaces and process captured data for use in simulation environments;
a simulation module configured to generate synthetic training scenarios based on scanned environments from the scanning module and vary environmental parameters including at least one of object size, object poses, lighting conditions, texture, color, background elements, edge cases, or any combination thereof;
and a data quality module configured to evaluate the synthetic training scenarios against quality metrics and guide further data generation based on coverage needs.

25. The robotic control system of claim 20, further comprising:
a demonstration interface configured to receive one or more demonstrations of a target skill and at least one of: voice prompts, natural language prompts, text prompts, or a combination thereof, describing desired robot behavior;
a model selection module configured to process the text prompts to determine task requirements and select appropriate foundation models for a given task by comparing predicted actions from different foundation models against demonstration actions, evaluating visual or task similarity metrics, and using user-applied labels, categories, or any combination thereof; and
a foundation learning module configured to adapt a selected foundation model using the demonstrations and incorporate the text prompts to guide task execution.

26. The robotic control system of claim 20, wherein the system further comprises:
an interface configured to enable temporal segmentation of demonstration videos;
a labeling module configured to associate text labels with video segments and track labeled actions across demonstrations; and
a training module configured to use labeled segments for targeted skill learning.

27. A method for robot programming comprising:
receiving robot program steps;
automatically generating natural language descriptions of robot actions for at least one step based on:
force data, torque data, or force-torque data corresponding to sensed interaction forces between a robot and a corresponding environment, and
visual data corresponding to a vantage point of a user while performing one or more physical actions; and
using the natural language descriptions, creating a human-readable narrative sequence of at least one robot program based on at least one of:
robot configuration data,
robot action parameters, or
any combination thereof.

28. The method of claim 27, further comprising:
enabling temporal segmentation of demonstration videos through an interface;
associating text labels with video segments and tracking labeled actions across demonstrations through a labeling module; and
using labeled segments for targeted skill learning through a training module.
